(19) United States
(12) Patent Application Publication
(10) Pub. No.: US 2007/0093966 A1
(43) Pub. Date: Apr. 26, 2007

(54) Drug candidate selection by hydrogen exchange characterization of ligand-induced receptor conformation

(75) Inventors: Mark Robert Southern, Cranford, NJ (US); Yoshitomo Hamuro, Somerset, NJ (US); Patrick Robert Griffin, Jupiter, FL (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: ExSAR CORPORATION, Monmouth Junction, NJ (US)

(21) Appl. No.: 10/559,157

(22) PCT Filed: Jul. 2, 2004
(86) PCT No.: PCT/US04/21472

§ 371 Date: Dec. 5, 2005

(51) Int. Cl. G06F 19/00; G06G 7/48

(52) U.S. Cl. 702/19; 703/11

(57) ABSTRACT

A method is provided of selecting a compound that (a) binds a receptor, and (b) on binding the receptor, induces a perturbation in the conformation of the receptor, which conformational perturbation is correlated with a particular pharmacological activity.

### FIELD OF THE INVENTION

The present invention relates to methods of identifying drug candidates which, on binding a receptor, cause a particular conformational perturbation in the receptor. Perturbation of the receptor structure is correlated with a particular pharmacological activity profile.

### BACKGROUND OF THE INVENTION

I. Analysis of Proteins by Isotopic Hydrogen Exchange Methods

Isotopic hydrogen exchange analysis may reveal perturbations in the structure or conformation of a protein. See, Chamberlain & Marqusee, Structure, July 15; 5(7): 859-63 1997; Engen & Smith, Anal Chem., May 1; 73(9): 256A-265A. 2001; Englander et al., Protein Sci., May; 6(5): 1101-9, Review, 1997; Rodriguez et al., Biochemistry, 2002 Feb. 19; 41(7): 2140-8 2002; Sivaraman et al., Methods Mol. Biol.; 168: 193-214. 2001; Englander & Kallenbach, Q. Rev. Biophys., November; 16(4): 521-655, 1983; Englander et al., Proc. Natl. Acad. Sci. USA., August 5; 94(16): 8545-50, 1997; Thevenon-Emeric et al., Anal Chem., October 15; 64(20): 2456-8. 1992; Zhang & Smith, Protein Science, 2:522-531, 1993, the entire disclosures of which are incorporated herein by reference.

A. Exchangeable Hydrogens.

Hydrogens in a protein may be categorized into three groups with respect to rates of isotopic hydrogen exchange: (1) fast exchange hydrogens, e.g., OH, SH, NH₂, COOH, and side chain CONH, (2) medium exchange hydrogens, such as backbone peptide amide hydrogens, and (3) slow exchange hydrogens, such as alkyl and aromatic hydrogens. Fast exchanging hydrogens have rates of exchange with protic solvent hydrogens too rapid to be useful for real time measurement. Alkyl and aromatic (C—H) hydrogens, or slow exchange hydrogens, exchange measurably only when activated (e.g., by a chemical treatment that serves to abstract a proton, such as treatment with hydroxyl radical).

By contrast, many main chain peptide amide hydrogens have measurable exchange rates ranging from seconds to days. The reaction occurs without harsh treatments maintaining the native structure of the protein. Thus, these medium exchange rates may be followed in real time by isotopic hydrogen exchange. Amide hydrogens may be exchanged with exchangeable hydrogen or isotopic hydrogen atoms on a protic solvent through acid, base, and water catalyzed reactions.

B. “Intrinsic” Amide Hydrogen Exchange Rate.

NMR studies have provided sufficient data to predict “intrinsic” amide hydrogen exchange rate for a given sequence, pH, temperature and type of isotope exchange (e.g., H [symbol] D, and H [symbol] T), in a random coil conformation. See, Englander & Englander, 1994, Meth. Enzymol. 232:26-42; and Bai et al., 1995, Meth. Enzymol. 259:344-356, the entire disclosures of which are incorporated herein by reference. Hydrogen exchange of a typical peptide amide occurs on the order of ten milliseconds to one second on a protein in a random coil conformation, at room temperature, and at pH 7.

C. Amide Hydrogen Exchange Rate in Native Protein Structures

The exchange rate of an amide hydrogen may change when a protein is folded from a random coil into its native structure or any other structure. The change in hydrogen exchange rate is dependent on the protein structure and dynamics. Factors such as involvement in hydrogen bonding, the degree to which the hydrogen is buried within the folded protein (i.e., sequestered from solvent exposure), and the flexibility of the peptide chain alter the exchange rate of peptide amide hydrogens. A decrease in hydrogen exchange rate in the folded protein is referred to as the protection factor upon folding. The protection factor may be as high as 10⁸. Some amide hydrogens having high protection factors exchange with a half life on the order of years at neutral pH and room temperature.

The hydrogen deuterium exchange pattern obtained for a certain protein under specific experimental conditions is a reflection or marker of the conformation of the protein under these specific environmental conditions.

II. Computer-Assisted Identification of Potential Receptor Ligands

Drug discovery efforts generally proceed via identification of a pool of drug candidates that have an affinity for a receptor that mediates a particular disorder. The pool of drug candidates is ideally a group of compounds that bind the receptor (i.e. act as receptor ligands). Rational selection of potential ligands for a receptor may decrease the number of compounds that must be screened in order to identify a drug candidate. Processes for rational selection of potential receptor ligands may comprise computer-assisted modeling and searching technologies. Selection of potential ligands may be accomplished by utilizing structural information from the ligand-binding site of a receptor and/or from identified receptor ligands.

When the structure of a receptor ligand binding site or pocket is known, potential ligands may be identified by modeling the receptor, potential ligands, and the docking of the potential ligands into the ligand binding site. Docking approaches may be classified based on how the receptor ligand binding site is characterized.

Grid-search techniques characterize the receptor ligand binding site by filling the space around the binding site with a 3-D grid. Potentials, such as van der Waals or electrostatic potentials, are computed at each grid point in the absence of a ligand. Then, different ligand conformations and orientations are sampled on the grid and the resultant binding energy for each is computed.

Rational selection of potential ligands can be accomplished by modeling ligands docking to a receptor using molecular mechanics force field methodologies. Force field methodologies model short range and long range forces between a receptor and a potential ligand using field representations. See, U.S. Pat. No. 5,866,343, the entire disclosure of which is incorporated herein by reference. The interaction energy between the receptor and a potential ligand may then be calculated for the position of the ligand relative to the receptor. The ligand position is adjusted iteratively and an interaction energy is calculated for each iteration. This method continues until a minimum energy interaction is found.

A grid template may be constructed for ligand binding based upon favorable interaction points in the receptor ligand binding site. The search for a favorable ligand binding mode may generate different conformations of the potential ligand. Partial structures of the potential ligand may be matched to complementary template points as a basis for docking the potential ligand into the receptor ligand binding site.

A template incorporates known features of ligand binding, such as experimentally observed interactions of known ligands. Thus the search is reduced by restricting the docking space to match a fixed number of atoms of the potential ligand onto a fixed number of template points. This is favorable compared to the six-dimensional orientational search space (three degrees of rotational freedom and three degrees of translational freedom) required in other approaches for sampling and evaluating ligand binding.

One advantage of grid-based docking is that a template of favorable interactions in the receptor ligand binding site need not be predefined. This reduces bias in modeling the receptor-ligand interactions. Evaluation of binding modes may be made more efficient by precomputing potential energy that results from interaction of a potential ligand with the receptor at each point on the grid. The accuracy and time requirements of this approach are directly related to the fineness of the grid. Accuracy is only gained at the expense of increased computational time. Computational time is a factor in screening databases of potential ligands wherein large numbers of potential ligands, each comprising multiple orientations and conformations, are assayed.

AUTODOCK is a computer program often employed to explore docking of potential ligands to receptors. See, Morris et al., J. Computational Chemistry, 19(1998), 1639-1662, the entire disclosure of which is incorporated herein by reference. AUTODOCK employs a protocol termed “simulated annealing.” The expression “simulated annealing” is adopted from the process of annealing (i.e., obtaining a crystalline structure of a material by heating and then slowly cooling it). “Simulated annealing” is a Monte Carlo approach to the minimization of molecular conformations; wherein, the temperature is incrementally lowered until no further conformational changes in the modeled protein occur. The simulation must proceed long enough at each temperature increment for the system to reach conformational equilibrium. In “simulated annealing,” the protein molecule is initialized with a particular conformation. A new conformation is constructed by imposing a random displacement of the initial conformation. If the energy of the displaced conformation is lower than that of the previous one, the change is accepted unconditionally and the receptor conformation is updated. If the energy is greater, the displaced conformation is accepted probabilistically. This fundamental procedure allows the modeled conformation approach a global energy minimum, and avoids entrapment in local energy minima.

Newer versions of AUTODOCK provide a hybrid genetic algorithm to sample feasible binding nodes of a potential ligand relative to a receptor. A genetic algorithm generates and evaluates a large number of solutions comprising incrementally translated and/or rotated conformational states of the potential ligand. The genetic algorithm provides a fitness function that evaluates each solution, assessing its contribution to succeeding generations of solutions.

DOCK is another computer program used to model binding interactions. See, Schoichet et al., J. Comput. Chem. 13 (1992) 380, the entire disclosure of which is incorporated herein by reference. DOCK generates a template composed of spheres, typically up to 100 spheres, that provide a negative image of a receptor ligand binding site. Subsets of ligand atoms are matched to spheres, based on the distances between ligand atoms. DOCK is capable of considering chemistry and hydrogen-bonding interaction in addition to the template shape.

Other template approaches to receptor ligand selection specify a set of interaction points defining favorable positions for placing polar or nonpolar atoms or functional groups. Such a template may be generated automatically, by placing probe points on the solvent accessible surface of the binding site. Alternatively, these templates may be generated interactively by superimposing known receptor-ligand complexes to identify potentially favorable interaction points based on observed binding modes for known ligands.

The docking program, FLEXX (Tripos® Inc.; 1699 South Hanley Road, St. Louis, Mo. 63144-2913) employs a template of 400 to 800 points to define positions for favorable interactions of hydrogen-bond donors and acceptors, metal ions, aromatic rings, and methyl groups. The potential ligand is fragmented, incrementally reconstructed in the binding site and matched to template points based on geometric indexing techniques.

The docking program, HAMMERHEAD provides up to 300 hydrogen-bond donor, acceptor, and van der Waals interaction points to define a template. See, Welch et al., AN. Chem Biol 3(1996), 449-462, the entire disclosure of which is incorporated herein by reference. A potential ligand may be incrementally constructed, as in FLEXX. A ligand fragment may be docked based on matching ligand atoms and template points with compatible internal distances, similar to the DOCK algorithm. If a new fragment is positioned close enough to the partially constructed ligand, HAMMERHEAD merges the two parts, retaining the best matching placements.

Other docking approaches, such as GOLD, and the method of Oshiro et al., provide genetic algorithms to sample possible matches of conformationally flexible ligands to the template. See, G. Jones et al., J. Mol. Biol. 267 (1997) 727-74, and Oshiro et al., J. Comput. Aided Mol. Des. 1995;9:113-130, the entire disclosures of which are incorporated herein by reference. GOLD provides a template based on hydrogen-bond donors and acceptors on the receptor and applies a genetic algorithm to sample all possible combinations of intermolecular hydrogen bonds and ligand conformations.

UNITY 3-D (Tripos® Inc.) includes a docking tool that provides six parameters corresponding to the six rotational/translational degrees of freedom. These parameters are adjusted to place pharmacophoric groups of a potential ligand at positions that provide favorable interactions with the receptor.

SPECITOPE combines grid methods with adaptive geometry techniques to model side chain flexibility in a receptor protein. See, Schnecke et al., Structure, Function, and Genetics, Vol. 33, No. 1, 1998, 74-87, the entire disclosure of which is incorporated herein by reference. SPECITOPE provides a binding site template to limit the orientational search for a potential ligand and employs distance geometry techniques to avoid computationally fitting infeasible ligands into a binding site.

III. Computer-Assisted Modeling for Prediction of Isotopic Hydrogen Exchange Profiles

Computer-assisted modeling of protein structure has been employed to assess the relative stability of protein substructures. Such stability modeling has been shown to correlate to experimentally derived hydrogen exchange profiles.

One algorithm, COREX, has been shown capable of modeling the hydrogen exchange data obtained for many receptor proteins. See, Freire, E., Proc. Nat. Acad. Sci. USA, 97, 11680-11682, 2000; Hilser et al., Proc. Nat. Acad. Sci. USA, 95, 9903-9908, 1998; Hilser et al., J. Mol. Biol., 262, 756-762, 1996; Hilser et al., Proc. Nat. Acad. Sci. USA, 95, 9903-9908, 1998; Hilser et al., Biophys. Chem., 64, 69-79, 1997; Hilser et al., Proteins, 27, 171-183, 1997; Sadqi et al., Biochemistry, 38, 8899-8906, 1999; and Luque et al., Proteins, 4, 63-71, 2000; the entire disclosures of which are incorporated herein by reference.

The COREX algorithm models a receptor as a statistical ensemble of conformational states. Each conformational state is characterized by having a region or regions in a nonfolded state. The size of the nonfolded regions may be from four or five amino acids up to the entire protein. Division of the protein into a given number of folding units is called a partition. Different partitions may be included in the analysis to maximize the number of distinct partially folded states. Each partition may be defined by placing a block of windows over the entire sequence of the protein. The folding units are defined by the location of the windows independent of correlation with specific secondary structural features of the protein. Different partitions of the protein are obtained by sliding the entire block of windows one residue at a time.

The computation may be performed exhaustively for smaller receptors (e.g., less than 150 residues). For larger receptors, the computation may be performed employing a sampling technique wherein some minimum (e.g., 20,000) conformational states are generated.

The COREX algorithm produces a “snapshot” of the distribution of states existing under equilibrium conditions. This distribution is identical to a distribution that would be obtained if a single protein receptor molecule were observed over an interval sufficient for thermodynamic averaging.

The COREX algorithm provides an opportunity to examine the effects of ligand binding. The incorporation of ligand linkage equations into the COREX algorithm correctly predicts the propagation of binding effects through the structure of hen egg white lysozyme upon binding of a specific antibody. See, Freire, E., Proc. Natl. Acad. Sci. USA.; 96 (18): 10118-10122, 1999, the entire disclosure of which is incorporated herein by reference.

IV. Ligand-Induced Perturbation of Receptor Conformation

Drug discovery efforts generally seek to find a receptor that mediates a disease and agents that bind to that receptor to effect a positive and selective modification of the disease. Such efforts have generally been directed to a few key strategies to generate new drugs.

One primary strategy seeks to identify drug candidates that have the highest affinity for the receptor. High affinity compounds are likely to have efficacy at lower and presumably safer doses compared to lower affinity compounds.

Different, but closely related subtypes of a receptor often exist, and selectivity for a single subtype may be sought. Drug candidates having a high selectivity for a receptor subtype may have a lower incidence of side effects mediated by interaction with multiple receptor subtypes.

Traditionally, compounds possessing sufficient receptor selectivity and sufficient receptor affinity constituted the desired drug profile. All agonists of a given receptor were assumed to uniformly stimulate their receptors.

Often, however, this assumption has proven inaccurate. Certain receptors mediate different biological responses on interaction with different ligands. These varied responses may be correlated with varied ligand-induced perturbation of the target receptor's conformation. A biological response mediated by a ligand binding to a receptor is often characterized by a binding mode as well as the magnitude of binding interaction. Examples of receptors that evidence ligand-induced conformational perturbation include nuclear receptors (NRs) (e.g., glucocorticoid receptor (GR), estrogen receptor (ER), peroxisome proliferator-activated receptor (PPAR), vitamin D receptor, liver X receptor and retinoic X receptor (RXR)), kinases, G-protein coupled receptors (e.g., alpha-amino-3-hydroxy-5-methylisoxazolepropionate (AMPA) receptor), and transcription factors other than nuclear receptors.

The determination of receptor-ligand recognition may be only a first step in drug candidate selection for receptors that demonstrate ligand-induced conformational perturbation. This is because different ligands may bind the same receptor with the same affinity, yet generate different receptor conformations and thereby elicit different pharmacological effects.

What is needed is a process for selecting, from a pool of drug candidates, compounds that, on binding a receptor, generate a receptor conformation that is correlated with a particular efficacy desired for a successful drug candidate. During optimization of the drug candidate to transform it to a pharmaceutically acceptable compound, the process should allow evaluation of the receptor conformation to make sure the optimized compounds have the same mode of interaction with the receptor.

V. Nuclear Receptors

NRs are ligand-inducible transcription factors that specifically regulate the expression of a wide range of target genes involved in metabolism, development, reproduction, etc. More than 100 NRs are known to exist. Examples of NRs include receptors for steroid hormones such as ER and GR, receptors for nonsteroidal ligands such as retinoic acid receptors (RAR), and fatty acid receptors such as the PPARs.

NRs contain multiple functional domains. A DNA-binding domain (DBD) directs the receptor to bind to specific DNA sequences as monomers, homodimers, or heterodimers. A ligand-binding domain (LBD) is the domain of the protein that responds to binding of a cognate ligand. Ligand-binding interactions can induce ligand-specific perturbation of NR conformation. Ligand-induced conformational perturbations can modulate the NRs interaction with certain specific receptor-binding DNA sequences and/or with other nuclear proteins or complexes of nuclear proteins (e.g., transcription factor complexes, coactivator complexes, and/or corepressor complexes). Coactivators and corepressors interact with NRs in a ligand-dependent fashion to facilitate activation of transcription (coactivators) or to inhibit transcriptional activation (corepressors) of genes which are transcriptionally modulated by a specific NRs. Thus, ligand-induced conformational perturbation in an NR serves to modulate the transcription of genes.

NRs are implicated in the control of a wide range of physiological responses and homeostatic conditions, including cell differentiation, neoplasia, control of cellular metabolism, and neurological function. Agonists and antagonists of endogenous NRs may provide potential drug leads for disease states subject to NR-mediated transcriptional control. Substantial interest exists in identification of new NR ligands.

Conventional assays for identifying potential NR ligands often comprise binding studies of libraries of small organic molecules. NR protein is incubated with a specific radiolabeled ligand and compounds are measured for their ability to displace the radiolabeled ligand. These conventional assays do yield high affinity ligands but they have limited success in identifying functionally selective compounds. There are several reasons selectivity to NR receptors is elusive. For these receptors activity may be uncoupled from binding affinity, functional selectivity may be driven by binding mode, and/or conformational change may be induced by the ligand.

Transcriptional assays provide analysis of ligand-induced transcriptional activation of a NR by monitoring a transcription event downstream of the ligand-NR binding interaction. Transcriptional assays comprise transcription of a reporter sequence operably linked to a NR response element and promoter. Transcriptional assays may however be relatively insensitive for monitoring expression of genes that are not abundantly transcribed. Thus, transcriptional responses generated by ligand-activated NRs often prove difficult to detect and/or quantify. Many transcription assays also require additional process steps, such as lysis of assayed cells.

NR ligands often exhibit pleiotropic biological effects mediated by NRs. For example, both estradiol and tamoxifen bind to estrogen receptor (ER), but produce different biological effects because the respective binding complexes modify different sets of genes. Reliable methods are needed of identifying NR ligands that elicit a single desired biological effect on NR binding.

PPARs comprise a group of at least three NR isoforms; PPARγ, PPARα(, and PPARδ, encoded by different genes. PPARs are ligand-regulated transcription factors that control gene expression by binding to specific peroxisome proliferator response elements (PPREs) within promoters. PPARs bind to the PPRE along with a retinoid X receptor (RXR) to form a heterodimeric complex. The PPAR conformation is changed on binding an agonist ligand. Transcriptional coactivators are recruited resulting in an increased rate of transcription. Antagonists binding to PPARs would have the opposite effect.

PPARs serve as lipid sensors and regulators of lipid metabolism. Fatty acids and eicosanoids have been identified as endogenous PPAR ligands. More potent synthetic PPAR ligands, including the fibrates and thiazolidinediones, have proven effective in the treatment of dyslipidemia and type 2 diabetes. Investigation of PPAR ligands has implicated the PPARs in numerous disorders, including atherosclerosis, inflammation, cancer, infertility, syndrome X, and demyelination.

PPARγ agonists act as antihyperglycaemic agents by increasing peripheral insulin sensitivity by a mechanism that is not completely understood. In addition, activation of PPARγ by some classes of agonists promotes enhanced adipogenesis. PPARγ agonists are observed to cause increased adiposity in animal models of insulin resistance. In clinical studies with human subjects, some patients were observed to have a dose-related increase in weight which may be a combination of fat accumulation and fluid retention. Other side effects observed in these studies include an increase in the median plasma volume leading to hemodilution and fluid retention or edema which can exacerbate or lead to congestive heart failure.

Many PPARγ agonists have activity that is proportional to their ability to bind and activate PPARγ. However, some PPARγ agonists demonstrate differential activity resulting from generation of different PPARγ conformational perturbations. One group of PPARγ agonists, the thiazolidinediones (TZDs), has yielded several drugs for the treatment of T2D. Three representative TZDs, pioglitazone (ACTOS®), rosiglitazone (AVANDIA®), and troglitazone (RIZULIN®, withdrawn from the US market by the manufacturer) are shown in Scheme 1.

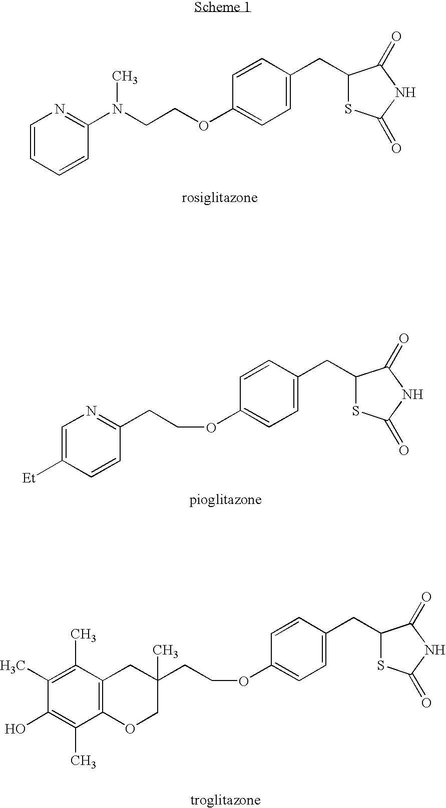

Camp et al., have shown that rosiglitazone and pioglitazone behave as full agonists, but that troglitazone profiles as a partial agonist in a promoter reporter assay. See, Camp, H. S. et al., 2000, Diabetes. 49:539-547, the entire disclosure of which is incorporated herein by reference. However, when Camp et al. examined the induction of the endogenous gene CAP in 3T3-L1 adipocytes, troglitazone profiled as a full agonist. Camp et al. showed that each of the three tested TZDs induced a unique set of genes. The three sets of genes induced by three TZDs did overlap, however the respective sets of genes were nonetheless substantially different. Thus, though all three TZDs bind to PPARγ, one TZD may alter the expression of a gene that is unaffected by administration of another TZD.

The three-dimensional conformation of the TZD-PPARγ complex may be different for each TZD ligand. Burant (1999, Diabetes 48 (Suppl. 1):44) has proposed the selective PPARγ modulator (SPPARM) model to explain the varying biological profiles of PPARγ ligands. The SPPARM model as depicted schematically in FIG. 1, may explain how a single receptor may respond to a ligand in a way that is gene context-specific. According to FIG. 1, Ligands 1, 2 and 3 each bind PPARγ. However, the three resulting receptor complexes show different ligand-specific conformations. The different PPARγ conformations may induce different interactions between PPARγ and other transcriptional machinery. The result may be different gene activation (or repression) profiles for each respective PPARγ ligand. For example, the different ligand-PPARγcomplexes may interact differently with a PPRE, thereby recruiting different sets of coactivators (or corepressors) and/or may interact with the PPRE with altered kinetics. Different PPAR ligands, working through the same PPAR receptor, may thus induce different responses.

Present therapeutic PPARγ agonists and some PPARγ agonists currently in late stages of development were developed prior to the proposal of the SPPARM model. There exists a need to accurately and efficiently identify PPARγ agonists that improve insulin resistance while affording a reduced liability for weight gain, plasma volume expansion and edema. To this end, a method is required to identify PPARγ agonists that can induce a conformational stabilization of the PPARγ ligand-dependent transcription complex which will mediate a particular transcriptional profile.

What is needed is an in vitro process of selecting receptor ligands capable of inducing a selected receptor conformation which corresponds to a selected pharmacological activity, and of experimentally assessing the degree to which the ligand-induced receptor conformation fits the selected receptor conformation.

### SUMMARY OF THE INVENTION

According to one embodiment of the invention, there is provided a method of screening a drug candidate for a selected pharmacological activity, said method comprising:
(a) selecting a receptor that demonstrates a perturbation of conformation when bound to a selected ligand, wherein said selected ligand is identified with the selected pharmacological activity;
(b) generating a hydrogen exchange profile of the receptor;
(c) generating a hydrogen exchange profile of a first receptor complex comprising the receptor bound to said selected ligand;
(d) defining a first perturbation of the receptor conformation, which perturbation is induced by binding of the receptor to the selected ligand;
(e) generating a hydrogen exchange profile of a second receptor complex comprising the receptor bound to said drug candidate;
(f) defining a second perturbation of the receptor conformation which perturbation is induced by binding of the receptor to the drug candidate; and
(g) comparing the first perturbation to the second perturbation, the similarity between the two perturbations of the receptor conformation being predictive of the drug candidate having the selected pharmacological activity.

The step of defining the first perturbation of the receptor conformation preferably comprises calculating the difference between the hydrogen exchange profile of the receptor and the hydrogen exchange profile of the receptor bound to the selected ligand.

The step of defining the second perturbation of the receptor conformation preferably comprises calculating the difference between the hydrogen exchange profile of the receptor and the hydrogen exchange profile of the receptor bound to the drug candidate.

Drug candidates screened by this method of the invention may be selected by computer-assisted modeling of the selected receptor.

According to some embodiments of the invention, said computer-assisted modeling comprises:

(a) modeling a binding interaction of at least one compound with the receptor to identify at least one potential receptor ligand; and

(b) selecting at least one potential receptor ligand as a drug candidate.

According to other embodiments of the invention, said computer-assisted modeling comprises:

(a) predicting at least one hydrogen exchange profile of the selected receptor bound to at least one potential drug candidate by modeling probable conformational states of the receptor bound to the at least one potential drug candidate;

(b) defining at least one conformational perturbation of the receptor predicted to be induced by binding of the receptor to the at least one potential drug candidate; and

(c) selecting a drug candidate wherein the predicted conformational perturbation is similar to a conformational perturbation of the receptor induced by binding of the receptor to a selected ligand, which selected ligand is identified with a selected pharmacological activity.

Preferably, the selected receptor according to the method of the invention comprises a protein.

According to some embodiments, the selected receptor is a nuclear receptor such as a glucocorticoid receptor, an estrogen receptor, a peroxisome proliferator-activated receptor, a vitamin D receptor, a liver X receptor or a retinoic X receptor; a kinase, such as c-JUN N-terminal kinase (JNK), glucokinase, p38 MAP kinase, or a receptor tyrosine kinase, and protein tyrosine phosphatases such as PTP1b; a G-protein coupled receptor such as alpha-amino-3-hydroxy-5-methylisoxazolepropionate (AMPA) receptor; or a transcription factor other than a nuclear receptor, such as NF-kB.

According to one embodiment of the invention, the step of generating a hydrogen exchange profile of a receptor or a complex comprises determining the quantity of isotopic hydrogen or the rate of hydrogen exchange, or both the quantity of isotopic hydrogen and the rate of hydrogen exchange, of a plurality of peptide amide hydrogens exchanged for said isotopic hydrogen in a receptor or receptor complex that is hydrogen-exchanged with a hydrogen isotope other than ¹H.

According to one embodiment, the step of determining the quantity of isotopic hydrogen or the rate of hydrogen exchange, or both the quantity of isotopic hydrogen and the rate of hydrogen exchange comprises the steps of:
(a) contacting the selected receptor or receptor complex with an isotopic hydrogen exchange reagent for a selected time interval to form a isotopic hydrogen-exchanged receptor or receptor complex;
(b) under slow hydrogen exchange conditions, progressively degrading the isotopic hydrogen-exchanged receptor or receptor complex to obtain a series of sequence-overlapping peptide fragments;
(c) measuring the amount of isotopic hydrogen contained in each peptide fragment; and
(d) correlating the amount of isotopic hydrogen contained in each peptide fragment with an amino acid sequence of the receptor or receptor complex from which the peptide fragment was generated, thereby determining the quantity of isotopic hydrogen or the rate of hydrogen exchange, or both the quantity of isotopic hydrogen and the rate of hydrogen exchange, of a plurality of peptide amide hydrogens exchanged for isotopic hydrogen in the receptor or receptor complex.

According to some embodiments, the step of progressively degrading comprises contacting the isotopic hydrogen-exchanged receptor or receptor complex with an acid-stable endopeptidase under conditions of slow hydrogen exchange, thereby generating a population of sequence-overlapping peptide fragments of said isotopic hydrogen-exchanged receptor or complex. In such instance the initial peptide fragments generated by cleavage of the protein substrate are progressively degraded into smaller fragments as a function of residence time with the endopeptidase. Preferably, the acid-stable endopeptidase is immobilized on a solid-phase support, and is selected from the group consisting of pepsin, Newlase, Aspergillus proteases, protease type XIII, and combinations thereof.

According to other embodiments, the step of progressively degrading comprises:
(a) fragmenting the isotopic hydrogen-exchanged receptor or receptor complex into a plurality of peptide fragments under slow hydrogen exchange conditions;
(b) identifying which peptide fragments of said plurality of peptide fragments are isotopic hydrogen-exchanged; and
(c) under slow hydrogen exchange conditions, sequentially terminally degrading the isotopic hydrogen-exchanged peptide fragments to obtain a series of subfragments, wherein each subfragment of the series is composed of from about one to about five fewer amino acid residues than the preceding subfragment in the series.

The step of fragmenting the isotopic hydrogen-exchanged receptor or complex preferably comprises contacting the isotopic hydrogen-exchanged receptor or complex with an acid-stable proteolytic enzyme.

The acid-stable proteolytic enzyme is preferably immobilized on a solid phase support, and is preferably selected from the group consisting of pepsin, Newlase, Aspergillus proteases, protease type XIII, and combinations thereof.

The step of sequentially terminally degrading the isotopic hydrogen-exchanged peptide fragments comprises reaction of those peptide fragments with an exopeptidase, preferably with an acid-resistant carboxypeptidase.

The acid-resistant carboxypeptidase is preferably selected from the group consisting of carboxypeptidase P, carboxypeptidase Y, carboxypeptidase W, carboxypeptidase C and combinations thereof, and is preferably immobilized on a solid phase support.

According to some embodiments of the invention, the isotopic hydrogen is deuterium. According to other embodiments of the invention the isotopic hydrogen is tritium.

When the isotopic hydrogen is tritium, the presence and quantity of tritium on the fragments or subfragments of the isotopic hydrogen-exchanged receptor or complex is preferably determined by measuring radioactivity of the subfragments.

When the isotopic hydrogen is deuterium, the presence and quantity of deuterium on the fragments or subfragments of the isotopic hydrogen-exchanged receptor is preferably determined by measuring the mass of the subfragments, such as by mass spectrometry.

According to some embodiments of the invention, the steps of determining the quantity of isotopic hydrogen and/or the rate of hydrogen exchange further comprise the use of conditions that effect protein denaturation, and/or disrupt disulfide bonds in the isotopic hydrogen-exchanged receptor under slow hydrogen exchange conditions prior to the step of progressive degradation.

Disruption of disulfide bonds in the isotopic hydrogen-exchanged receptor or complex may comprise for example, contacting the isotopic hydrogen-exchanged receptor with a phosphine such as, for example tris(2-carboxyethyl) phosphine (TCEP).

### Definitions

The term “ligand,” unless otherwise stated, refers to any molecule which is capable of binding a receptor.

The term “agonist,” unless otherwise stated, refers to a ligand that upon binding to a receptor triggers activation of a chemical or physical signaling cascade. This results in a definable change in the behavior, physical or biological state of a cell.

The term “antagonist,” unless otherwise stated, refers to a molecule that, by virtue of binding to a receptor, is able to block a cell-activating influence of the agonist.

The term “partial agonist,” unless otherwise stated, refers herein to a ligand that, upon binding to a receptor, triggers activation as defined for an agonist, but at less than the maximum response.

The expression “ligand-binding domain” or “LBD” refers to the portion of a receptor involved in binding a ligand.

The term “receptor,” unless otherwise stated, refers to any molecule capable of binding a ligand. Thus, a “receptor” refers not only to molecules generally recognized as belonging to the class of binding molecules designated as “biological receptors,” such as nuclear receptors, cytokine receptors, growth factor receptors, chemokine receptors, hormone receptors, adhesion receptors, or apoptosis receptors, but is also intended to include any molecule which can bind another molecule, for example, an antibody or an enzyme.

A “receptor” may be structurally identical (e.g., the same amino acid sequence) to a naturally occurring receptor, or may comprise a functionally active fragment, mutant or derivative of a naturally occurring receptor. The term “receptor” includes receptors that are bound to one or more other molecules (e.g., coactivators or corepressors, other than the ligand that binds to the ligand binding domain).

The term “receptor complex,” unless otherwise stated, refers to a complex formed when a receptor is bound to a ligand. The ligand may be a drug candidate or an endogenous ligand for the receptor or a protein binding partner such as a heterodimer partner, coactivator complex, or corepressor complex.

The expression “bound to a ligand” refers to the proximity between a ligand and a receptor where any appropriate physicochemical interaction including both covalent and non-covalent bonding occurs. Typically, the binding interaction is a non-covalent molecular interaction, for example, hydrogen bonding, van der Waals interaction, hydrophobic interaction, or electrostatic interaction, but can involve covalent bonds being formed.

The term “protein,” as used herein includes, mutatis mutandis, polypeptides, oligopeptides and derivatives thereof, including, by way of example and not limitation, glycoproteins, lipoproteins, phosphoproteins and metalloproteins. The essential requirement for a molecule to be considered a protein is that it comprises at least two amino acid residues covalently linked by peptide amide bonds. The amide hydrogen of the peptide bond and alkyl hydrogens on side chains of certain amino acid residues have certain properties which permit analysis by hydrogen exchange.

The expressions “perturbation of conformation” and “conformational perturbation” refer to a change in the three-dimensional conformation of a receptor that occurs as a result of the binding of the receptor to a ligand.

The expression “defining a perturbation” of a receptor conformation means any procedure whereby the three-dimensional conformation of a receptor unbound to a ligand is compared to the three-dimensional conformation of the same receptor bound to a ligand. This comparison characterizes at least one conformational difference in the two three-dimensional conformations.

The expression “hydrogen exchange profile” refers to an analysis of the hydrogen exchange of a receptor or receptor complex, wherein the rate of hydrogen exchange and/or the amount of hydrogen exchanged at all, or substantially all peptide amide hydrogens in the receptor or complex is analyzed.

The expression “isotopic hydrogen” refers to deuterium (²H) or tritium (³H) or a mixture thereof.

The expression “normal hydrogen” refers to hydrogen (¹H).

The expressions “hydrogen exchange” and “isotopic hydrogen exchange” refer to any chemical process wherein hydrogen atoms (normal or isotopic hydrogen) bonded to a molecule are exchanged for hydrogen atoms (normal or isotopic hydrogen) that are donated by a hydrogen exchange reagent.

The term “H/D exchange” refers to hydrogen exchange wherein hydrogen atoms in a molecule are exchanged for deuterium.

The expression “hydrogen exchange reagent” refers to a substance that readily exchanges hydrogen atoms (normal or isotopic hydrogen) with a substrate molecule containing exchangeable hydrogen atoms such as a receptor. A net exchange of hydrogen atoms to a receptor from the hydrogen exchange reagent occurs when the hydrogen exchange reagent is employed in substantial excess over the amount of the receptor. An “isotopic hydrogen exchange reagent” serves to exchange normal hydrogen (¹H) in the substrate molecule with isotopic hydrogen (²H or ³H, or a combination thereof). Examples of isotopic hydrogen exchange reagents include D₂O, T₂O and CF₃CO₂D. A “normal hydrogen exchange reagent” serves to exchange isotopic hydrogen in the substrate molecule for normal hydrogen. Examples of normal hydrogen exchange reagents include H₂O and CH₃OH.

The expression “proteolytic enzyme” means an enzyme that reacts with a protein and breaks one or more peptide amide bonds, thereby fragmenting the protein into two or more peptide fragments.

The expression “pharmacological activity” refers to a property of a substance, such as a drug, which is identified with the substance causing a biological response in an organism or a biological system associated with an organism, for example, in an in vitro assay.

The expression “computer-assisted modeling” refers to any computer-assisted technique used to discover, design, and optimize chemical compounds having a putative affinity for a biological receptor.

The expression “cluster analysis” refers to a collection of statistical techniques for creating homogeneous groups of cases or variables. Clusters are formed using distance functions. The elements in a cluster have relatively small distances from each other and relatively larger distances from elements outside of the cluster.

The expression “dendrogram” refers to a “tree-like” diagram for presenting the similarity or difference in data groups. At the “leaf” level of the tree is the individual data. Similar data are joined by ‘branches’ whose position in the diagram is determined by the level of similarity between the joined data. Branches may be between single datums and data groups that contain a number of individual datums.

The expression “centroid linkage” refers to a clustering mechanism whereby the distance between any two datums of data groups is evaluated using the averages of all of the data that they each contain. Centroid linkage may be robust in analysis of outlying data (i.e., data that deviate significantly from the mean), and may produce well defined clusters.

The expression “uncentered correlation” refers to a correlation distance function that takes into account the magnitude of two different vectors. An “uncentered correlation” thus contrasts with a standard Pearson correlation between two vectors which gives a value of 1 (perfect similarity) if the vector shape is identical even if the two vectors are offset from one other.

### DESCRIPTION OF THE FIGURES

FIG. 1 is a depiction of the SPPARM model of PPAR modulation wherein different receptor ligands generate different ligand-specific receptor conformational perturbations.

FIG. 2 is a protein fragmentation map showing the peptide fragments isolated by fragmentation of PPARγ LBD (SEQ ID NO: 1) with pepsin, quenched with aqueous solution containing 2M urea and 1M tris TCEP.

FIGS. 3a-3w are graphical representations of the H/D-Ex profiles of PPARγ LBD without bound ligand (-♦-), PPARγ LBD bound to drug candidate C1 (-▪-), PPARγ LBD bound to the drug candidate C2 (-▴-), and PPARγ LBD bound to the drug candidate C3 (-●-). Each graph shows the deuterium build-up curve for a peptide fragment consisting of the indicated amino acid sequence (see below), wherein the amino acid sequence numbers are based on the sequence of full length PPARγ LBD (SEQ ID NO: 2). H/D-Ex of the peptide fragments are shown, as follows:

FIG. 3a PPARγ LBD sequence 240-250;

FIG. 3b PPARγ LBD sequence 250-265;

FIG. 3c PPARγ LBD sequence 266-280;

FIG. 3d PPARγ LBD sequence 266-284;

FIG. 3e PPARγ LBD sequence 285-306;

FIG. 3f PPARγ LBD sequence 307-315;

FIG. 3g PPARγ LBD sequence 327-337;

FIG. 3h PPARγ LBD sequence 338-345

FIG. 3i PPARγ LBD sequence 346-355;

FIG. 3j PPARγ LBD sequence 353-358;

FIG. 3k PPARγ LBD sequence 359-368;

FIG. 3l PPARγ LBD sequence 369-379;

FIG. 3m PPARγ LBD sequence 380-391;

FIG. 3n PPARγ LBD sequence 392-398;

FIG. 3o PPARγ LBD sequence 399-405;

FIG. 3p PPARγ LBD sequence 405-412;

FIG. 3q PPARγ LBD sequence 419-429;

FIG. 3r PPARγ LBD sequence 445-459;

FIG. 3s PPARγ LBD sequence 460-470;

FIG. 3t PPARγ LBD sequence 471-480;

FIG. 3u PPARγ LBD sequence 481-491;

FIG. 3v PPARγ LBD sequence 492-497; and

FIG. 3w PPARγ LBD sequence 498-505.

FIGS. 4a-4w are graphical representations of H/D-Ex profiles of PPARγ LBD without a bound ligand (-♦-), PPARγ LBD bound to drug candidate C4 (-▪-), PPARγ LBD bound to drug candidate C5 (-▴-), and PPARγ LBD bound to drug candidate C6 (-●-). Each graph shows the deuterium build-up curve for a peptide fragment consisting of the indicated amino acid sequence, wherein the amino acid sequence numbers are based on the sequence of full length PPARγ. H/D-Ex of the peptide fragments are shown, as follows:

FIG. 4a PPARγ LBD sequence 240-250;

FIG. 4b PPARγ LBD sequence 250-265;

FIG. 4c PPARγ LBD sequence 266-280;

FIG. 4d PPARγ LBD sequence 266-284;

FIG. 4e PPARγ LBD sequence 285-306;

FIG. 4f PPARγ LBD sequence 307-315;

FIG. 4g PPARγ LBD sequence 327-337;

FIG. 4h PPARγ LBD sequence 338-345;

FIG. 4i PPARγ LBD sequence 346-355;

FIG. 4j PPARγ LBD sequence 353-358;

FIG. 4k PPARγ LBD sequence 359-368;

FIG. 4l PPARγ LBD sequence 369-379;

FIG. 4m PPARγ LBD sequence 380-391;

FIG. 4n PPARγ LBD sequence 392-398;

FIG. 4o PPARγ LBD sequence 399-405;

FIG. 4p PPARγ LBD sequence 405-412;

FIG. 4q PPARγ LBD sequence 419-429;

FIG. 4r PPARγ LBD sequence 445-459;

FIG. 4s PPARγ LBD sequence 460-470;

FIG. 4t PPARγ LBD sequence 471-480;

FIG. 4u PPARγ LBD sequence 481-491;

FIG. 4v PPARγ LBD sequence 492-497; and

FIG. 4w PPARγ LBD sequence 498-505.

FIGS. 5a-5w are graphical representations of H/D-Ex profiles of PPARγ LBD without a bound ligand. (-♦-), PPARγ LBD bound to drug candidate C7 (-▪-), PPARγ LBD bound to drug candidate C8 (-▴-), and PPARγ LBD bound to drug candidate C9 (-●-). Each graph shows the deuterium build-up curve for a peptide fragment consisting of the indicated amino acid sequence, wherein the amino acid sequence numbers are based on the sequence of full length PPARγ. H/D-Ex of the peptide fragments are shown, as follows:

FIG. 5a PPARγ LBD sequence 240-250;

FIG. 5b PPARγ LBD sequence 250-265;

FIG. 5c PPARγ LBD sequence 266-280;

FIG. 5d PPARγ LBD sequence 266-284;

FIG. 5e PPARγ LBD sequence 285-306;

FIG. 5f PPARγ LBD sequence 307-315;

FIG. 5g PPARγ LBD sequence 327-337;

FIG. 5h PPARγ LBD sequence 338-345;

FIG. 5i PPARγ LBD sequence 346-355;

FIG. 5j PPARγ LBD sequence 353-358;

FIG. 5k PPARγ LBD sequence 359-368;

FIG. 5l PPARγ LBD sequence 369-379;

FIG. 5m PPARγ LBD sequence 380-391;

FIG. 5n PPARγ LBD sequence 392-398;

FIG. 5o PPARγ LBD sequence 399-405;

FIG. 5p PPARγ LBD sequence 405-412;

FIG. 5q PPARγ LBD sequence 419-429;

FIG. 5r PPARγ LBD sequence 445-459;

FIG. 5s PPARγ LBD sequence 460-470;

FIG. 5t PPARγ LBD sequence 471-480;

FIG. 5u PPARγ LBD sequence 481-491;

FIG. 5v PPARγ LBD sequence 492-497; and

FIG. 5w PPARγ LBD sequence 498-505.

FIGS. 6a-6w are graphical representations of H/D-Ex profiles of PPARγ LBD without a bound ligand (-♦-), PPARγ LBD bound to drug candidate C10 (-▪-), PPARγ LBD bound to drug candidate C11 (-▴-), and PPARγ LBD bound to drug candidate C12 (-●-). Each graph shows the deuterium build-up curve for a peptide fragment consisting of the indicated amino acid sequence, wherein the amino acid sequence numbers are based on the sequence of full length PPARγ. H/D-Ex of the peptide fragments are shown, as follows:

FIG. 6a PPARγ LBD sequence 240-250;

FIG. 6b PPARγ LBD sequence 250-265;

FIG. 6c PPARγ LBD sequence 266-280;

FIG. 6d PPARγ LBD sequence 266-284;

FIG. 6e PPARγ LBD sequence 285-306;

FIG. 6f PPARγ LBD sequence 307-315;

FIG. 6g PPARγ LBD sequence 327-337;

FIG. 6h PPARγ LBD sequence 338-345;

FIG. 6i PPARγ LBD sequence 346-355;

FIG. 6j PPARγ LBD sequence 353-358;

FIG. 6k PPARγ LBD sequence 359-368;

FIG. 6l PPARγ LBD sequence 369-379;

FIG. 6m PPARγ LBD sequence 380-391;

FIG. 6n PPARγ LBD sequence 392-398;

FIG. 6o PPARγ LBD sequence 399-405;

FIG. 6p PPARγ LBD sequence 405-412;

FIG. 6q PPARγ LBD sequence 419-429;

FIG. 6r PPARγ LBD sequence 445-459;

FIG. 6s PPARγ LBD sequence 460-470;

FIG. 6t PPARγ LBD sequence 471-480;

FIG. 6u PPARγ LBD sequence 481-491;

FIG. 6v PPARγ LBD sequence 492-497; and

FIG. 6w PPARγ LBD sequence 498-505.

FIGS. 7a-7w are graphical representations of H/D-Ex profiles of PPARγ LBD without a bound ligand (-♦-), PPARγ LBD bound to drug candidate C13 (-●-), PPARγ LBD bound to drug candidate C14 (-▴-), and PPARγ LBD bound to drug candidate C15 (-●-). Each graph shows the deuterium build-up curve for a peptide fragment consisting of the indicated amino acid sequence, wherein the amino acid sequence numbers are based on the sequence of full length PPARγ. H/D-Ex of the peptide fragments are shown, as follows:

FIG. 7a PPARγ LBD sequence 240-250;

FIG. 7b PPARγ LBD sequence 250-265;

FIG. 7c PPARγ LBD sequence 266-280;

FIG. 7d PPARγ LBD sequence 266-284;

FIG. 7e PPARγ LBD sequence 285-306;

FIG. 7f PPARγ LBD sequence 307-315;

FIG. 7g PPARγ LBD sequence 327-337;

FIG. 7h PPARγ LBD sequence 338-345;

FIG. 7i PPARγ LBD sequence 346-355;

FIG. 7j PPARγ LBD sequence 353-358;

FIG. 7k PPARγ LBD sequence 359-368;

FIG. 7l PPARγ LBD sequence 369-379;

FIG. 7m PPARγ LBD sequence 380-391;

FIG. 7n PPARγ LBD sequence 392-398;

FIG. 7o PPARγ LBD sequence 399-405;

FIG. 7p PPARγ LBD sequence 405-412;

FIG. 7q PPARγ LBD sequence 419-429;

FIG. 7r PPARγ LBD sequence 445-459;

FIG. 7s PPARγ LBD sequence 460-470;

FIG. 7t PPARγ LBD sequence 471-480;

FIG. 7u PPARγ LBD sequence 481-491;

FIG. 7v PPARγ LBD sequence 492-497; and

FIG. 7w PPARγ LBD sequence 498-505.

FIGS. 8a-8w are graphical representations of H/D-Ex profiles of PPARγ LBD without a bound ligand (-♦-), PPARγ LBD bound to drug candidate C16 (-●-), PPARγ LBD bound to drug candidate C17 (-▴-), and PPARγ LBD bound to drug candidate C18 (-●-). Each graph shows the deuterium build-up curve for a peptide fragment consisting of the indicated amino acid sequence, wherein the amino acid sequence numbers are based on the sequence of full length PPARγ. H/D-Ex of the peptide fragments are shown, as follows:

FIG. 8a PPARγ LBD sequence 240-250;

FIG. 8b PPARγ LBD sequence 250-265;

FIG. 8c PPARγ LBD sequence 266-280;

FIG. 8d PPARγ LBD sequence 266-284;

FIG. 8e PPARγ LBD sequence 285-306;

FIG. 8f PPARγ LBD sequence 307-315;

FIG. 8g PPARγ LBD sequence 327-337;

FIG. 8h PPARγ LBD sequence 338-345;

FIG. 8i PPARγ LBD sequence 346-355;

FIG. 8j PPARγ LBD sequence 353-358;

FIG. 8k PPARγ LBD sequence 359-368;

FIG. 8l PPARγ LBD sequence 369-379;

FIG. 8m PPARγ LBD sequence 380-391;

FIG. 8n PPARγ LBD sequence 392-398;

FIG. 8o PPARγ LBD sequence 399-405;

FIG. 8p PPARγ LBD sequence 405-412;

FIG. 8q PPARγ LBD sequence 419-429;

FIG. 8r PPARγ LBD sequence 445-459;

FIG. 8s PPARγ LBD sequence 460-470;

FIG. 8t PPARγ LBD sequence 471-480;

FIG. 8u PPARγ LBD sequence 481-491;

FIG. 8v PPARγ LBD sequence 492-497; and

FIG. 8w PPARγ LBD sequence 498-505.

FIG. 9 depicts the result of Cluster Analysis of H/D-Ex profile data for PPARγLBD bound to each of drug candidates C1-C18.

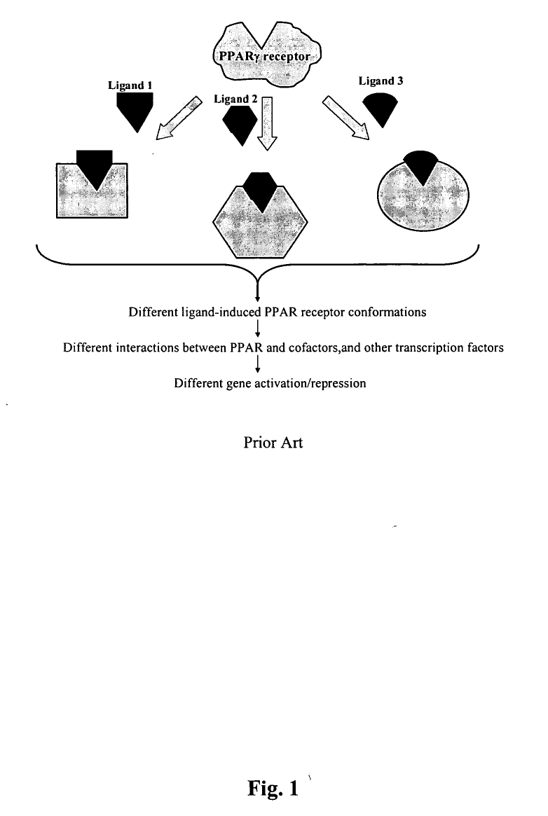

### DETAILED DESCRIPTION OF THE INVENTION

The present invention provides a process for selecting a compound, capable of binding to a receptor and inducing a conformational perturbation of the receptor, which perturbation is associated with, or identified with, a selected pharmacological activity. The selection of the compound comprises selecting a compound that, on binding the receptor, induces a conformational perturbation that is similar to the perturbation induced by a known receptor ligand possessing a specific pharmacological activity.

The selection process may begin by screening a group of chemical compounds, preferably a large chemical compound library, or a sub-set of compounds from a library that are known to interact with the specific receptor or preferably commences with computer-assisted modeling to select a group of drug candidates from a pool of potential receptor ligands. This selection of the drug candidate group is followed by characterization via hydrogen exchange analyses of perturbations of the receptor conformation that are induced in the receptor by the binding interaction of the receptor with each drug candidate. Potential receptor ligands predicted, preferably by computer-assisted modeling or by screening, to be capable of binding the receptor are referred to herein as “drug candidates.”

The receptor is contacted with a drug candidate to form a receptor complex. Hydrogen exchange profiles are generated for the unliganded receptor and for the receptor complex. Perturbations in the receptor conformation induced by binding of the drug candidate are revealed by calculating the difference between the hydrogen exchange profile of the receptor complex and the hydrogen exchange profile of the unliganded receptor. The conformational perturbation thus revealed may be compared to a perturbation of the receptor conformation induced by a selected receptor ligand that is a known ligand of the receptor and is associated with or identified with a known pharmacological activity.

The method of the invention is based on the principle that changes in hydrogen exchange rates of exchangeable hydrogens in a receptor or complex constitute detectable and quantifiable changes in the immediate environment surrounding each exchangeable hydrogen in the receptor. The exchangeable hydrogens that undergo changes in exchange rates upon formation of a ligand-receptor complex correspond to the hydrogens whose environments change as a result of ligand binding. When the binding interaction of different drug candidates produces different perturbations in the conformation of the receptor, there will be different populations of exchangeable hydrogens whose local environment will detectable and quantifiably change.

A known pharmacological activity associated with a selected receptor ligand may, in some instances, be a desirable pharmacological profile or activity. In such instances, the method of the invention may be directed to selecting drug candidates that induce a perturbation in receptor conformation that is similar to the perturbation induced by the selected ligand. Alternately, the known pharmacological activity associated with the selected ligand may represent an undesired toxicity or side effect. In such cases, the method of the invention may be directed to selecting against drug candidates that induce a perturbation in receptor conformation that is similar to that induced by the selected ligand. Thus, the method of the invention may be employed for positive or negative selection of drug candidates to include or exclude compounds predicted to have a pharmacological activity similar to that of a selected ligand.

I. Selection of Drug Candidates

The selection process may begin by screening a group of chemical compounds, preferably a large chemical compound library, or a sub-set of compounds from a library that are known to interact with the specific receptor. Preferably, computer-assisted modeling is employed to initially select drug candidates suitable for further screening according to the present invention. Such modeling methods may comprise methods of
(a) modeling of binding interactions of a potential ligand with a receptor to identify potential receptor ligands that will bind to the receptor binding site; and/or
(b) predicting isotopic hydrogen exchange profiles of complexes of the receptor with potential receptor ligands to identify potential drug candidates that, when bound to the receptor, may yield hydrogen exchange profiles that correspond to conformational perturbations similar to a conformational perturbation induced by binding to the receptor of a selected ligand which is identified with a selected pharmacological activity.
   Either (a) or (b), or both (a) and (b), may be employed to select a group of drug candidates for screening according to the method of the invention.
   A. Selection of Drug Candidates by Computer-Assisted Modeling of Binding Interactions

Potential ligands of a receptor may be identified by computer-assisted modeling. Compounds unlikely to bind to the receptor may, by initial computer-assisted modeling, be eliminated from further consideration. Early elimination of compounds unlikely to have receptor affinity focuses drug discovery resources on drug candidates that are rationally selected as potential receptor ligands. Conversely, early elimination of such compounds eliminates the time, expense, and resource that would be otherwise necessary for synthesis, purification, characterization, and screening of large numbers of compounds that are unlikely to have affinity for the receptor.

Modeling of binding interactions of potential ligands of a receptor may be done by modeling the docking of each potential ligand to the receptor ligand binding site. Modeling may comprise modeling the receptor ligand binding site by providing atomic coordinates comprising the receptor ligand binding site (or a functional portion thereof) to a computerized modeling system, and identifying compounds that fit spatially into the ligand binding site. By a “functional portion thereof” is meant a subset of the atoms of the receptor ligand binding site sufficient to interact with a compound that is capable of binding to the ligand binding site. Thus, the atomic coordinates provided to the modeling system may contain, for example, all the atoms of a receptor ligand binding site, a functional subset of the atoms a receptor ligand binding site such as atoms corresponding to the coactivator binding site, or a subset of atoms useful in the modeling and design of compounds that bind to a coactivator binding site.

The atomic coordinates of a compound known to bind the receptor ligand binding site may be used for modeling potential ligands that bind to the ligand binding site. Modeling of the binding of potential ligands to the receptor ligand binding site comprises quantitative and qualitative analyses of molecular structure and/or function based on atomic structural information. Such modeling includes conventional numeric-based molecular dynamic and energy minimization models, interactive computer graphic models, modified molecular mechanics models, distance geometry, and other structure-based constraint models.

Docking algorithms and computer programs that employ them may be used to identify compounds that spatially fit into the receptor ligand binding site. The expression “spatially fits” means that the three-dimensional structure of a compound may be accommodated geometrically by a cavity or pocket of a receptor ligand binding site. Compounds that spatially fit into the ligand binding site may interact with one or more of the amino acid residues that form the ligand binding site.

Fragment-based docking may also be employed to build molecules de novo inside the modeled receptor ligand binding site. Fragment-based docking positions chemical fragments in the receptor ligand binding site to optimize the geometry of the binding interactions. Fragment-based docking allows the design of a compound which is complementary to the structure of the receptor ligand binding site.

Compounds fitting the ligand binding site may serve as a starting point for an iterative design, synthesis and test cycle wherein new compounds are selected and optimized for desired properties including affinity, efficacy, and selectivity. Compounds may be subjected to derivatization, e.g., by replacement and/or addition of R-group substituents on a core structure identified for a particular class of ligands. Derivatives may be modeled, or synthesized and screened if desired.

Molecule databases of potential ligands may be screened for chemical entities that can bind in whole, or in part, to a receptor ligand binding site. The quality of fit of such entities to the ligand binding site may be assessed either by shape complementarity or by estimated interaction energy. See, DesJalais et al., J. Med. Chem. (1988) 31:722-729) and Meng et al., J. Comp. Chem. (1992) 13:505-524, the entire disclosures of which are incorporated herein by reference. Molecule databases may include any virtual or physical database (e.g., electronic and physical compound library databases).

Potential ligands may be designed rationally by exploiting available structural and functional information, thereby developing quantitative structure-activity relationships (QSARs). QSARs may be used to design new compound libraries, particularly focused libraries having chemical diversity of one or more specific portions of a core structure. The process of screening chemical entities or fragments for their ability to bind a receptor may begin by visual inspection of, for example, the receptor ligand binding site on a computer screen. Selected fragments or chemical entities may then be positioned into all or part of the receptor ligand binding site. Docking may be accomplished using software such as DOCK, AUTODOCK, FLEXX, HAMMERHEAD, GOLD, SPECITOPE, UNITY-3D or SYBYL, followed by energy minimization and molecular dynamics with standard molecular mechanics force-fields, such as CHARMM or AMBER.

Compounds may be designed to spatially fill the receptor ligand binding site. Residues comprising a ligand binding site, may be defined by the user as those residues having an atom within a specified distance (e.g., in the range from about 3 to about 10 Å) of an atom of a docked chemical entity. Modeling may search for energetic contributions and interaction of residues with the docked chemical entity. For example, a compound may be designed to contain hydrophobic groups that interact with hydrophobic residues of the ligand binding site. Molecules that mimic one or more of these particular interactions may also be designed, for example, by including one or more R-groups that are hydrophobic and fit into the site.

Computer programs may also assist in the process of selecting chemical entity fragments or whole compounds. Such programs include: AUTODOCK (Goodsell et al., Proteins: Structure, Function and Genetics (1990) 8:195-202; available from Scripps Research Institute, La Jolla, Calif.); and DOCK (Kuntz et al, J. Mol. Biol. (1982) 161:269-288; available from University of California, San Francisco, Calif.).

Compounds that bind to a receptor may be designed using either an empty receptor ligand binding site or optionally including some portion or portions of a molecule known to bind to the ligand binding site. Software tools used for such methods include: LUDI (Bohm, J. Comp. Aid. Molec. Design (1992) 6:61-78; (available from Biosym. Technologies, San Diego, Calif.); LEGEND (Nishibata et al., Tetrahedron (1991) 47:8985; (available from Molecular Simulations, Burlington, Mass.); and LEAPFROG (available from Tripos® Associates, St. Louis, Mo.). The entire disclosures of the above references are incorporated herein by reference.

In addition, computer-assisted modeling may be iterative with the screening method of the invention. Thus, a particular drug candidate may be identified by the method of the invention as inducing a conformational perturbation of the receptor which is similar to the perturbation induced by a selected receptor ligand which is identified with a particular pharmacological activity. The particular drug candidate may then be employed in computer-assisted modeling methods described herein in further refining the computer model of receptor binding interactions. Such refinement of the computer model may provide for improved selection of drug candidates for screening by the method of the invention.

Other molecular modeling techniques may also be employed in accordance with this invention. The model-building techniques, software and methods of docking small molecules which are described herein are not a limitation on the present invention.

Using computer-assisted modeling of binding interactions a large number of compounds may be quickly and easily examined as potential receptor ligands. Expensive and lengthy binding assays may thus be avoided. Moreover, the need for actual synthesis of many potential ligands likely to have low receptor affinity may be reduced or eliminated.

In the event that no three-dimensional structure of the receptor is available, standard high throughput screening may be employed to discover lead compounds. Standard medicinal chemistry optimization of these lead compounds may be employed without the aid of computer-assisted algorithms.

B. Predicting the Isotopic Hydrogen Exchange Profile of a Complex of a Receptor with a Potential Receptor Ligand.

The method of the present invention may also comprise prediction of the hydrogen exchange profile of a receptor complex. A hydrogen exchange profile predicted by computer-assisted modeling may be used to reveal a conformational perturbation predicted to be induced by a potential drug candidate on binding the receptor. Such a predicted conformational perturbation may be compared with (a) an experimentally-derived conformational perturbation induced by a selected ligand, or (b) with a conformational perturbation induced by a selected ligand which is predicted by computer assisted modeling. Drug candidates may thereby be identified which may potentially bind the receptor to induce a conformational perturbation similar to that induced by a selected receptor ligand.

Prediction of isotopic hydrogen exchange profiles of a receptor or complex may be done using a computer program such as COREX which models the structural distribution of Gibbs energy of stabilization of a protein. The isotopic hydrogen exchange profile prediction may be done on the unliganded receptor, and on a receptor bound to (a) a compound identified, as described herein, by a computer docking model as competent to bind with the receptor, or (b) a compound experimentally shown to bind the receptor. The conformational perturbation predicted to be induced by the binding of the receptor to the ligand is determined by calculating the difference between the predicted hydrogen exchange profile of the receptor bound to the ligand and either (a) the predicted hydrogen exchange profile of the unliganded receptor, or (b) an experimentally determined hydrogen exchange profile of the unliganded receptor.

II. Hydrogen Exchange Profile of a Receptor or Receptor Complex

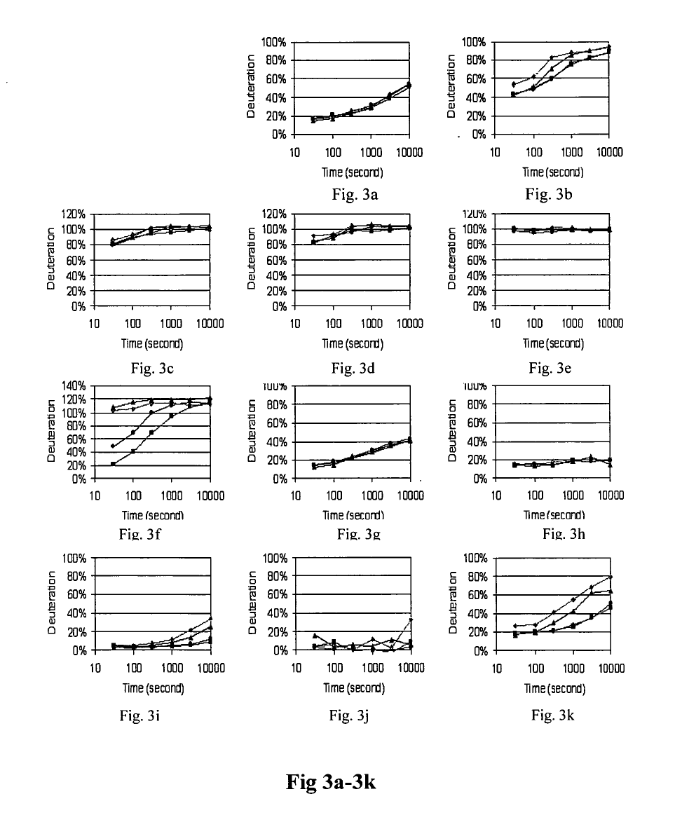

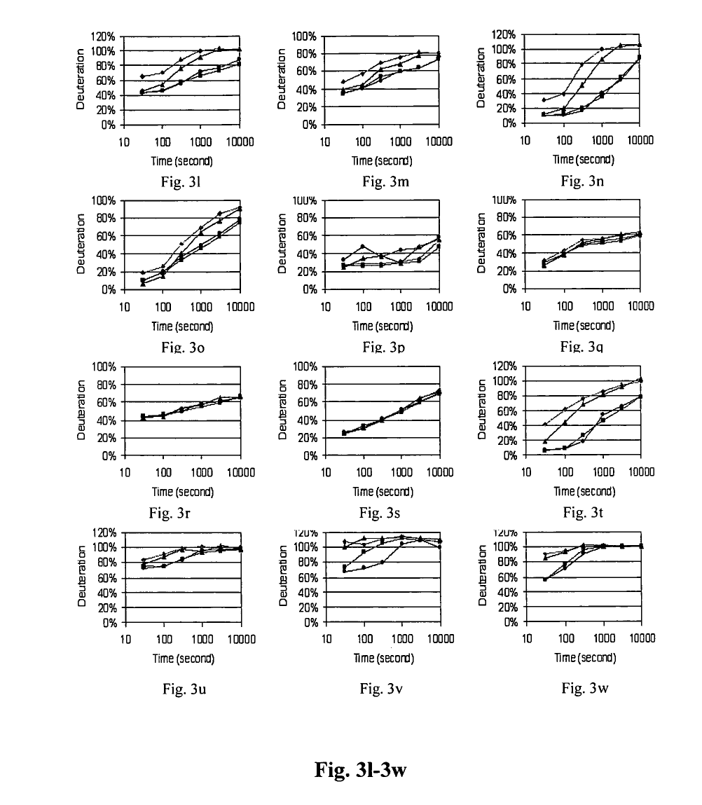

According to the present invention, a hydrogen exchange profile is generated for (i) a receptor, (ii) a first receptor complex comprising a receptor bound to a selected ligand, and (iii) a second receptor complex comprising the receptor bound to a drug candidate. The profiles are generated via analysis of hydrogen exchange of exchangeable hydrogens, preferably peptide amide hydrogens, in the receptor or receptor complex. The hydrogen exchange rate is related to the extent of amide hydrogen bonding and solvent accessibility of the amide hydrogen atom on the receptor or complex. The hydrogen exchange profile of a receptor or complex may be expressed as a map of the receptor correlating the amino acid sequence of the receptor to the amount of isotopic hydrogen exchanged into each exchangeable hydrogen atom position (e.g., peptide amide position). Such a map may be generated according to the invention by fragmenting the receptor into peptide fragments and measuring the amount of isotopic hydrogen incorporated by hydrogen exchange into each peptide fragment. One example of hydrogen exchange profiles expressed as maps of a receptor are shown in FIG. 3a-3w, wherein hydrogen exchange profiles of PPARγ LBD unbound and bound to drug candidates C1, C2, and C3 are shown.

A. Analysis of Hydrogen Exchange Rates of a Receptor or Complex

Analysis of hydrogen exchange rates may be carried out according to the disclosure of U.S. Pat. Nos. 5,658,739, 6,331,400, 6,291,189 and 6,599,707, the entire disclosures of which are incorporated herein by reference.

Hydrogen exchange rates of peptide amides of receptors, receptor-ligand complexes and receptor-drug candidate complexes are measured either during “on-exchange” of isotopic hydrogen into the receptor or complex, or during the “off-exchange” of isotopic hydrogen from the receptor or complex.

(i) Analysis of Hydrogen Exchange Rates During On-Exchange of Isotopic Hydrogen

On-exchange of isotopic hydrogen into the receptor or receptor complex may be carried out by contacting the receptor or complex with an isotopic (deuterium or tritium) hydrogen exchange reagent (e.g., D₂O, T₂O, or CF₃CO₂D) for a suitable incubation time interval. The exchange is preferably performed under conditions (i.e., pH, temperature, ionic strength, presence of buffer salts and concentration) wherein the receptor adopts the conformation that would be adopted in vivo. During the incubation, isotopic hydrogen from the isotopic hydrogen exchange reagent exchanges with solvent-accessible peptide amide hydrogens of the receptor or complex, thereby “on-exchanging” the solvent-accessible portions thereof. The rate of exchange of each amide hydrogen is related to its particular degree of solvent accessibility and extent of hydrogen bond formation.

The on-exchange is preferably conducted at a temperature in the range from about 0° C. to about 50° C., more preferably at about physiological temperatures, for example, from about 30° C. to about 40° C. The on-exchange is preferably conducted at about physiological buffer and pH conditions, for example, about 0.15 mM NaCl, about 10 mM PO₄, and about pH 7.4. Preferably, the on-exchange is performed with small incubation volumes, for example, in the range from about 0.1 to about 10 μl, and high concentrations of the receptor, for example, in the range from about 0.1 to 10 mg/mL.

A range of on-exchange time intervals may be employed. The range preferably spans several orders of magnitude (seconds to days) to allow selection of suitable on-exchange times which allow efficient exchange of the various peptide amides present in the receptor. For example, in FIGS. 3a-3w, the depicted hydrogen exchange profile comprises deuterium on-exchange time intervals of 30, 100, 300, 1000, 3000 and 10,000 seconds. On-exchange times are preferably in the range from about 10 seconds to about 24 hours. More preferably, the on-exchange time is in the range from about 10 seconds to about 8 hours, still more preferably from about 10 seconds to about 10,000 seconds. The on-exchange reaction time intervals employed may vary, and may be experimentally determined for the specific receptor or complex analyzed.

The on-exchange time interval or series of time intervals may be achieved by dispensing a solution of the receptor into a plurality of aliquots. The receptor sample contained in each aliquot may be then on-exchanged for an incrementally different period of time. The same series of on-exchange intervals may alternatively be obtained by initiating a single on-exchange reaction and removing and quenching aliquots from the on-exchanging sample at selected time intervals. Thus, each quenched aliquot represents on-exchange of isotopic hydrogen for a specific time interval in a sequential series of regular time intervals.

The isotopic hydrogen on-exchange reaction is “quenched,” or terminated, preferably by changing the reaction conditions to slow exchange conditions. “Slow hydrogen exchange conditions” are defined as conditions wherein the rate of exchange of isotopic hydrogen for normal hydrogen at solvent accessible peptide amide hydrogens may be reduced substantially thereby to provide sufficient time to determine, by the methods described herein, the locations of peptide amide hydrogens which have been exchanged with isotopic hydrogen. The hydrogen exchange rate is a function of variables such as temperature, pH, and solvent, in addition to chemical structure. The rate is decreased approximately three fold for each 10° C. drop in temperature from the preferred hydrogen exchange reaction temperature. In water, the hydrogen exchange rate is a function of pH such that the minimum hydrogen exchange rate is at a pH in the range from about 2 to about 3. The hydrogen exchange rate in water is also a function of temperature such that the minimum hydrogen exchange rate is at a pH in the range from about 0 to about 10° C. Thus, temperatures in the range from about 0 to about 10° C., and a pH in the range from about 2 to about 3 are preferred conditions of slow hydrogen exchange. Most preferred are conditions of a temperature in the range from about 0° to about 4° C., and a pH in the range from about 2.2 to about 2.7. The hydrogen exchange rate increases, typically by about 10-fold per pH unit increase or decrease away from the preferred optimum pH range. High concentrations of a polar, organic co-solvent serve to shift the optimum pH to higher pH, potentially to a pH of about 6, or even higher.

At a pH of about 2.2 and a temperature of about 0° C., the typical half life of isotopic hydrogen at a solvent accessible peptide amide position is about 70 minutes. Preferably, the slow hydrogen exchange conditions employed in methods of the present invention result in a half-life of isotopic hydrogen at a peptide amide of at least about 10 minutes, more preferably at least about 60 minutes.

(ii) Analysis of Hydrogen Exchange Rates During Off-Exchange of Isotopic Hydrogen

Alternatively, peptide amide hydrogen exchange rates may be determined by quantifying the amount of isotopic hydrogen at each residue in the isotopic hydrogen-exchanged receptor or complex as a function of off-exchange time. For analyses during off-exchange, the receptor or complex is first on-exchanged for a period of time sufficient to completely, or saturably, exchange the solvent-accessible amide hydrogens in the receptor or complex with isotopic hydrogen. By complete exchange of the solvent-accessible portion of the receptor or complex with isotopic hydrogen, is meant preferably at least about 90%, more preferably, about 95%, 96%, 97%, 98%, 99%, or even more, of the solvent-accessible exchangeable hydrogens in the receptor or complex are exchanged with isotopic hydrogen. The isotopic hydrogen-exchanged receptor or complex may be then off-exchanged as a function of time.

Off-exchange of the isotopic hydrogen-exchanged receptor or complex may be accomplished by contacting the receptor or complex with a normal hydrogen exchange reagent under the same conditions of pH, ionic strength, and buffer salts as were employed for on-exchange. Isotopic hydrogens in solvent-accessible portions of the isotopic hydrogen-exchanged receptor or complex are exchanged with normal hydrogens in the normal hydrogen exchange reagent. The off-exchange of isotopic hydrogen occurs at rates that are a function of hydrogen bonding and the solvent accessibility of the peptide amides in the receptor or complex.

The off-exchange as a function of time may be accomplished by dispensing the on-exchanged receptor or complex into a plurality of aliquots and off-exchanging each aliquot for a different period of time. Alternately, off-exchange as a function of time may be accomplished by removing and quenching aliquots from an off-exchanging solution of the receptor or complex at selected time intervals. The off-exchange reaction time interval is preferably in the range from about 10 seconds to about 24 hours. More preferably, the off-exchange time is in the range from about 10 seconds to about 8 hours, still more preferably from about 10 seconds to about 10,000 seconds. The off-exchange reaction time intervals employed may vary, and may be experimentally determined for the specific receptor or complex analyzed.

The off-exchange is preferably conducted at a temperature in the range from about 0° C. to about 50° C., more preferably at about physiological temperatures (e.g., from about 30° to about 40° C.). The off-exchange is preferably conducted at about physiological buffer and pH conditions, for example, about 0.15 mM NaCl, about 10 mM PO₄, and about pH 7.4.

B. Localization and Quantification of Isotopic Hydrogen Exchanged into a Receptor

The location and quantity of isotopic hydrogen exchanged into the receptor may be determined by various techniques, including, for example, enzymatic and/or chemical decomposition of the receptor followed by NMR analysis, radiation measurement (for tritium-exchanged receptor), or mass spectrometry. Mass spectrometry is preferably employed for localization and quantification of isotopic hydrogen.

Localization and quantification of isotopic hydrogen-exchanged peptide amide hydrogens may be complicated by back-exchange with solvent and cross-exchange from one amide hydrogen to another due to the lability of peptide amide hydrogens under most conditions. Consequently, degradation of a receptor whose peptide amide hydrogens have been isotopically exchanged should be carried out under slow hydrogen exchange conditions.

(i) Localization of Exchanged Isotopic Hydrogen by Fragmentation of the Receptor

The quantities and locations of isotopic hydrogen in an isotopic hydrogen-exchanged receptor or receptor complex may be determined by fragmentation of the receptor. Fragmentation of the receptor preferably comprises progressive degradation of the receptor. Methods of progressive degradation are described in U.S. Pat. Nos. 5,658,739, 6,291,189, and 6,331,400, and published U.S. patent application 2002 0042080, the entire disclosures of which are incorporated herein by reference. Progressive degradation may be carried out by one-step or two-step fragmentation methods.

Prior to either fragmentation method, the isotopic hydrogen-exchanged receptor or complex is shifted to conditions of slow hydrogen exchange. Slow hydrogen exchange conditions serve to substantially decrease the rate of peptide amide hydrogen exchange, essentially “freezing” in place the isotopic hydrogen atoms exchanged into the receptor for a time interval sufficient to complete an analysis of the hydrogen exchange profile of the receptor or complex. In addition, the slow hydrogen exchange conditions generally serve to dissociate a receptor from a ligand to which it is bound. Optionally, the receptor or complex may also be shifted to conditions of slow hydrogen exchange which simultaneously denature the receptor. Conditions that denature a receptor will also serve to dissociate a receptor ligand complex.

(a) One-Step Fragmentation

According to a one-step fragmentation process, the receptor is fragmented to generate a densely sequence-overlapping population of peptide fragments, preferably having sizes in the range from about 5 to about 25 amino acids. Receptor fragmentation may be accomplished using any fragmentation method that operates under the conditions of slow hydrogen exchange, such as proteolytic fragmentation, chemical fragmentation or fragmentation in a mass spectrometer. Receptor fragmentation is preferably achieved using one or more acid-stable proteolytic enzymes, for example, pepsin, newlase, Aspergillus proteases, and protease type XIII, and mixtures thereof. The acid-stable proteolytic enzyme is preferably immobilized (e.g., on a solid support) and preferably covalently coupled to a solid support matrix such as Agarose or Poros RTM media (AL-20). Preferably, the acid-stable proteolytic enzyme comprises pepsin. The fragmentation is preferably performed under slow hydrogen exchange conditions over a time interval in the range from about 0.1 to about 20 minutes, more preferably from about 1 to about 3 minutes, most preferably about 2 minutes.

The location within the receptor or complex of each isotopic hydrogen-exchanged peptide amide hydrogen is determined by analysis of the hydrogen isotope content of the peptide fragments. The fragments are separated from one another under conditions of slow hydrogen exchange by, for example, HPLC. The isotopic hydrogen-exchanged fragments are identified, for example, by radioactivity measurements (for tritium exchange), or by mass spectrometry or NMR, and isolated.

Data is generated by isotopic hydrogen exchange of a receptor or complex followed by fragmentation of the receptor or complex into peptide fragments. The generated data comprises a map of the peptide fragments correlated with the amount of isotopic hydrogen detected for each peptide fragment. Once the protease fragmentation data is acquired on the isotopic hydrogen-exchanged receptor, the data is deconvoluted to correlate the series of peptide fragments with the linear amino acid sequence of the receptor. This deconvolution serves to determine the position of isotopic hydrogen-exchanged into peptide amides in the receptor structure. The term “deconvoluted” as used herein refers to the mapping of information regarding the quantity and location of isotopic hydrogen incorporated into the amino acid sequence of the isotopic hydrogen-exchanged receptor. The mapping serves to ascertain from the fragmentation data the location of each isotopic hydrogen-exchanged peptide amide in the amino acid sequence of the receptor or complex, and optionally their rates of exchange. Deconvolution may comprise comparing the quantity and/or rate of exchange of isotopic hydrogen on a plurality of proteolytically-generated peptide fragments with the quantity and rate of exchange of isotopic hydrogen on at least one other proteolytically-generated fragment in the population of peptide fragments generated. The quantities of isotopic hydrogen are corrected for back-exchange in an amino acid sequence-specific manner.

The term “back-exchange” refers to loss of isotopic hydrogen from the isotopic hydrogen-exchanged receptor or complex which occurs via continuing hydrogen exchange with the solvent that occurs during the analysis process, subsequent to the quench of the isotopic hydrogen exchange reaction. Correction for back-exchange may be accomplished by a method that calculates an average correction factor for all amides in a peptide. See, Zhang et al., Prot. Sci. 2:522-531, 1993, the entire disclosure of which is incorporated herein by reference. Alternately, the method of the invention may employ a correction that is sub-site-specific (i.e., specific for 1-5 contiguous peptide amides). The correction may be carried out computationally by employing the Bai/Englander-algorithm. See, Bai et al., Proteins: Struct. Funct. Genet. 17:75-86, 1993, the entire disclosure of which is incorporated herein by reference.

Correction for back-exchange may also be carried out experimentally by measuring the back exchange, under quench conditions, of the substantially random coil fragments resulting from identical fragmentation of a saturably isotopic hydrogen-exchanged sample of the receptor in a manner that allows the rate(s) of loss of isotopic hydrogen to be measured over time for each peptide fragment. Both the computational and the experimental approaches to back-exchange correction afford precise calculation of the loss of isotopic hydrogen through back-exchange.

A preferred deconvolution algorithm for high density, overlapping peptide fragment data takes as inputs the measurements of the quantity of isotopic hydrogen on each of the overlapping peptide fragments (corrected for back-exchange), correlated with the amino acid sequence of each peptide fragment. The deconvolution algorithm compares the corrected isotopic hydrogen content of each peptide fragment with the isotopic hydrogen content of all peptides with which it, or immediately adjoining peptide fragments, share any part of the amino acid sequence of the parent receptor. The comparisons are performed in a manner that allows differences in isotopic hydrogen content to be assigned to portions of the amino acid sequence corresponding to sequence overlap of two or more peptide fragments. The preferred deconvolution algorithm fits isotopic hydrogen location and quantity at each location in a manner that optimizes agreement between results obtained from the plurality of peptide fragments.

(b) Two-Step Fragmentation

According to a two-step fragmentation process, the receptor or complex is subjected to a first fragmentation, under slow hydrogen exchange conditions. This first fragmentation is followed by isolation of isotopic hydrogen-exchanged fragments and a second fragmentation comprising sequential terminal degradation of the isolated hydrogen-exchanged peptide fragments to form subfragments.

1. First Fragmentation

The first fragmentation may be accomplished by employing an acid-stable proteolytic enzyme. The first fragmentation is preferably carried out using high concentrations of at least one protease that is stable and proteolytically active under slow hydrogen exchange conditions. Suitable proteases include, endoproteases, for example, pepsin (Rogero et al., Meth. Enzymol. 131:508-517, 1986.), cathepsin-D (Takayuki et al., Meth. Enzymol. 80:565-581, 1981) Aspergillus proteases (Krishnan et al., J. Chromatography 329:165-170, 1985; Xiaoming et al., Carlsberg Res. Commun. 54:241-249, 1989; Zhu et al., App. Envir. Microbiol. 56:837-843, 1990), thermolysin (Fusek et al., J. Biol. Chem. 265:1496-1501, 1990) and mixtures of these proteases. The proteolytic enzyme is preferably immobilized on a solid phase support. Pepsin is preferred, preferably at a concentration of about 10 mg/mL, preferably at a temperature of about 0° C. and preferably at a pH of about 2.3. For fragmentation with pepsin, the receptor is preferably contacted with pepsin for a time interval in the range from about 0.1 to about 30 minutes, more preferably for about 2 minutes. The resolution of the isotopic hydrogen-exchanged amides is equivalent to the peptide fragment size. Finer localization of the isotopic hydrogen is achieved by analysis of subfragments which are prepared by isolating the peptide fragments produced by the first fragmentation step which contain isotopic hydrogen, and subfragmenting those peptide fragments, preferably by sequential terminal degradation.

2. Isolation of Peptide Fragments Containing Isotopic Hydrogen

Isolation of individual isotopic hydrogen-exchanged peptide fragments produced by the first fragmentation step may be accomplished by reverse phase (RP) high performance liquid chromatography (HPLC) utilizing one or more of a number of chromatographic stationary phases, including, for example, Si—C4, Si—C18, Si(C18)₃, Si-phenol, Si-phenyl and ion exchange. The preferred chromatographic stationary phase is Si—C18, i.e., octadecylsilane.

Isolating each isotopic hydrogen-exchanged fragment from among the many peptide fragments generated by the first fragmentation is done under slow hydrogen exchange conditions. HPLC separations of peptide fragments is preferably performed at a pH in the range from about 2.1 to about 3.5 and at a temperature in the range from about 0° to about 4.0° C., more preferably, at a pH of about 2.3 and at a temperature of about 0° C. Peptide fragments are eluted from the reverse phase column using a mobile phase that comprises water and one or more polar co-solvents, wherein the mobile phase further comprises a buffer system. The preferred separation conditions may be generated by employment of any buffer system which operates within the above pH ranges, including, for example, citrate, phosphate, and acetate buffers. Phosphate buffers are preferred. The mobile phase may comprise a gradient of the one or more polar co-solvents, or may comprise isocratic conditions wherein the composition of the mobile phase is kept constant throughout the separation. A gradient of the one or more polar co-solvents is preferred. Preferred polar co-solvents include methanol, dioxane, propanol, acetonitrile and mixtures thereof. Acetonitrile is particularly preferred. Eluted peptide fragments are detected, preferably by ultraviolet spectroscopy performed at frequencies preferably in the range from about 200 nm to about 300 nm, more preferably at about 214 nm. The isotopic hydrogen is detected in a sampled fraction of the HPLC column effluent, preferably via scintillation counting (for tritium exchange) or by mass spectrometry (for deuterium exchange).

The first receptor fragmentation may produce a large number of different peptide fragments due to nonspecific cleavage by the proteolytic enzyme. HPLC isolation of all peptide fragments containing isotopic hydrogen may be substantially improved by employing a two-dimensional separation (i.e., two sequential HPLC separations). Preferably, the two sequential HPLC separations are preferably performed at similar pH, around pH 2.3. HPLC fractions from the first of the two sequential separations, which contain isotopic hydrogen-exchanged peptide fragments, are optionally subjected to a second HPLC separation. The second separation may be performed at a pH in the range in the range from about 2.1 to about 3.5 and at a temperature in the range of from about 0° to about 4° C., more preferably, at a pH of about 2.3 and at a temperature of about 0° C. Preferred solvents, buffers, and methods of detection and identification of the isotopic hydrogen-exchanged fragments are the same as those employed in the first HPLC separation. Isotopic hydrogen-exchanged peptide fragments are isolated by collection of the appropriate fraction of column effluent. Elution solvents are removed by evaporation. The amino acid sequence of the isolated isotopic hydrogen-containing peptide fragments is determined by conventional techniques such as, for example, amino acid analysis of complete acid hydrolysates, gas-phase Edman degradation microsequencing, or by tandem mass spectrometry. The location of the isotopic hydrogen-exchanged peptide fragments within the primary sequence of the intact receptor may then be determined by referencing the known amino acid sequence of the intact receptor.

Residual phosphate frequently interferes with chemical reactions required for amino acid analysis and Edman degradation. This interference may be eliminated by the inclusion of trifluoroacetic acid (TFA) in the second dimension buffer so that no residual salt (i.e., phosphate) remains after solvent evaporation.

3. Second Fragmentation—Sequential Terminal Degradation

Peptide fragments containing isotopic hydrogen are subjected to sequential terminal degradation under slow hydrogen exchange conditions. A peptide fragment is said to be “sequentially terminally degraded” if a series of fragments are obtained which are similar to the series of fragments which would be achieved using an ideal exopeptidase. Ideal exopeptidases only remove a terminal amino acid. Thus, if the n amino acids of a peptide fragment were labeled Aₗ to Aₙ (the numbering starting at the terminus at which the degradation occurs), the series of subfragments produced by an ideal exopeptidase would be A₂- - - Aₙ, A₃- - - Aₙ₋₁- - - Aₙ; Aₙ₋₁- - - Aₙ, and finally Aₙ.

Ideally, each subfragment of the series of subfragments obtained would be shorter than the preceding subfragment in the series by a single terminal amino acid residue. However, it is understood that exopeptidases do not always react ideally. Thus, for the method of the present invention, a peptide fragment is said to be sequentially terminally degraded, if the series of subfragments generated thereby is one wherein each subfragment in the series is composed of from about one to about five fewer terminal amino acid residues than the preceding subfragment in the series. The analyses of the successive subfragments are correlated in order to determine which amino acids of the parent peptide fragment were exchanged with isotopic hydrogen.

Sequential terminal degradation is preferably achieved by treatment of the peptide fragment with at least one acid-stable proteolytic enzyme, more preferably with at least one carboxypeptidase. Carboxypeptidases are able to generate all required subfragments of proteolytically-generated peptide fragments in quantities sufficient for localization of an isotopic hydrogen within a peptide fragment. The need to minimize isotopic hydrogen losses precludes the use of carboxypeptidases which are inactive under slow hydrogen exchange conditions, such as carboxypeptidases A and B. However, many carboxypeptidases are active under slow hydrogen exchange conditions and sequentially cleave amino acids from the carboxy terminus of peptide fragments. Such enzymes include, for example, carboxypeptidases P, Y, W, and C. See, Breddam, Carlsberg Res. Commun. 51:83-128, 1986, the entire disclosure of which is incorporated herein by reference.

The sequential terminal degradation is preferably carried out such that the reaction produces a complete set of peptide subfragments in analytically sufficient quantities, wherein each subfragment is preferably shorter than the preceding subfragment by from about one to about five carboxy terminal amino acids, more preferably by a single carboxy-terminal amino acid. As each carboxy-terminal amino acid of the isotopic hydrogen-exchanged peptide fragment is sequentially cleaved by the carboxypeptidase, the peptide amide nitrogen which exhibits slow hydrogen exchange under slow hydrogen exchange conditions is converted to a secondary amine which exhibits rapid hydrogen exchange. Thus, any isotopic hydrogen atom at that nitrogen is lost from the peptide subfragment within seconds, even under slow hydrogen exchange conditions. A difference in the molar quantity of isotopic hydrogen associated with any two sequential subfragments indicates that the isotopic hydrogen is localized at the peptide bond amide between the two subfragments.

Quantification of isotopic hydrogen at each isotopic hydrogen-exchanged amide, for example by radioactivity (for tritium) or mass spectroscopy measurements, as a function of varying on- or off-exchange time intervals, yields the hydrogen exchange rate for each residue of the isotopic hydrogen-exchanged peptide fragments. The positions of the amino acid residues are then correlated within the primary amino acid sequence of the receptor to yield the quantity of isotopic hydrogen and/or the exchange rates of the amide hydrogens in the receptor.

(c) Denaturation and Disruption of Disulfide Bonds in the Receptor.

Fragmentation of a receptor may be limited by lowered activity of proteolytic enzymes under slow hydrogen exchange conditions. Fragmentation of the receptor under slow hydrogen exchange conditions may be facilitated by denaturation of the receptor prior to fragmentation.

The isotopic hydrogen-exchanged receptor may be exposed, before fragmentation, to denaturing conditions compatible with slow hydrogen exchange. Analyses according to the invention should be performed rapidly, such that the exchangeable hydrogen is substantially retained at isotopic hydrogen-exchanged peptide amides of the receptor for the duration of the analysis. Preferably, the denaturing conditions are suitable to rapidly denature the receptor to a degree sufficient to render the receptor adequately susceptible to fragmentation. Denaturing conditions should not however, be sufficient to denature the proteolytic enzyme employed in the fragmentation reaction.

The receptor may be denatured prior to addition of a proteolytic enzyme, by an initial denaturant that rapidly denatures the receptor and would also denature the proteolytic enzyme if the proteolytic enzyme were present. After the receptor is denatured, the composition of the initial denaturant may be adjusted to conditions wherein the receptor remains denatured, but a proteolytic enzyme, when added, will not be appreciably denatured.

One preferred initial denaturant composition is urea, preferably at a concentration in the range of from about 1 to about 8 M, more preferably at a concentration greater than or equal to about 2 M.

Disulfide bonds, if present in the receptor to be fragmented, may limit the effectiveness of the fragmentation reaction. Failure to disrupt disulfide bonds may reduce resolution in localization of the isotopic hydrogen in peptide fragments still joined to each other by one or more disulfide bonds. The presence of disulfide bonds further complicates the two-step fragmentation method, because multiple carboxy termini could exist on a single peptide fragment. If disulfide bonds are not disrupted, further sublocalization of the isotopic hydrogen-exchanged peptide amides within each of the disulfide-joined peptides would proceed, at different times and at different rates, at each carboxy terminal of the disulfide linked segments of the peptide fragment.

In conventional protein structure studies, disulfide bonds are cleaved by reduction with, for example, 2-mercaptoethanol or dithiothreitol. These reagents require a pH greater than 6 and elevated temperature to achieve sufficient activity, and thus are of limited use for the reduction of disulfides under the slow hydrogen exchange conditions required by the methods of the present invention.

Phosphines such as tris(2-carboxyethyl) phosphine (TCEP) may be used to disrupt disulfide bonds under slow hydrogen exchange conditions. TCEP may however be relatively inefficient at disulfide bond reduction under slow hydrogen exchange conditions.

Denaturation without concomitant disulfide bond reduction of the receptor may be accomplished by contacting the receptor with a solution containing ≧2 molar guanidine thiocyanate, at a temperature in the range from about 0° to about 5° C., at a pH of about 2.7, followed by the addition of an equal volume of 4 M guanidine hydrochloride at a pH of about 2.7.

Denaturation with simultaneous disulfide bond reduction may be accomplished by contacting the receptor with a solution containing ≧2 molar guanidine thiocyanate, TCEP at a concentration in the range from about 0.3 to about 0.7M, and H₂O (in the range from about 5 to about 20% by volume). The balance of volume is made up of acetonitrile, dimethyl sulfoxide, or other water miscible nonaqueous solvent in which the denaturant, e.g., guanidine thiocyanate, and the disulfide bond disrupting agent (e.g., TCEP) if used, remain soluble at the required concentrations. Also, these conditions ensure the solvent system remains fluid at the temperature required to maintain slow hydrogen exchange conditions. The pH of the denaturation solution is preferably in the range from about 4.8 to about 5.2, more preferably about 5.0. When denaturation and/or disulfide bond reduction are complete, about 2 volumes of guanidine hydrochloride solution (about 2.5 molar) is added. The pH and buffering capacity of the guanidine hydrochloride solution are preferably sufficient to achieve a pH of about 2.7 in the final mixture of denatured receptor prepared for the fragmentation reaction.

The denatured receptor, with or without disulfide bond reduction, is then fragmented, preferably by passing the solution at a temperature of about 0° C. and a pH of about 2.7 through a column comprising of pepsin bound to a solid support. The denatured receptor is thereby substantially completely fragmented by the pepsin to peptide fragments of sizes in the range from 1 to about 20 amino acids. The product of the fragmentation reaction is preferably directly and immediately applied to the procedure employed to separate and isolate peptide fragments, preferably by reverse-phase HPLC.

(ii) Localization of Isotopic Hydrogen-Exchanged Amide Hydrogens by Mass Spectrometry

According to another fragmentation method, fragmentation of the receptor protein may be accomplished within a mass spectrometer. Typically, when a protein is fragmented in a mass spectrometer employing conditions conventionally employed for mass spectrum analysis, amide hydrogens become scrambled (i.e., exchange positions with other amide hydrogens within the same protein). However, by performing ion-trap mass spectroscopy and operating the mass spectrometer below a predetermined scrambling threshold fragmentation energy, such exchange may be avoided or minimized. (See, for example, Deng et al., “Selective Isotope Labeling Demonstrates That Hydrogen Exchange at Individual Peptide Amide Linkages Can Be Determined by Collision-Induced Dissociation Mass Spectrometry”, Journal of the American Chemical Society; 121(9), 1966-1967, (1999); and Smith, et al., “Probing the Non-covalent Structure of Proteins by Amide Hydrogen Exchange and Mass Spectrometry”, Journal of Mass Spectrometry, 32, 135-146, (1997)), the entire disclosures of which are incorporated herein by reference.

IV. Forming a Receptor-Ligand Complex

According to the invention, hydrogen exchange profiles are generated for a complex comprising the receptor bound to a ligand, and a complex comprising the receptor bound to a drug candidate. Formation of a receptor complex comprises combining the ligand or drug candidate with the receptor, preferably in quantities sufficient to produce saturation binding to the receptor (excess ligand over receptor on a molar basis). The complex formation is preferably performed at high concentrations (e.g., 0.1-10 mg/mL) so as to maximize the rate and extent of binding of the ligand or drug candidate.

Once the ligand or drug candidate has bound to the receptor, the receptor may undergo a conformational change from the unbound receptor conformation to a conformation reflecting a ligand-specific perturbation of the receptor conformation. The set of amide hydrogens which make up the solvent accessible portion of the receptor structure may not the same for the perturbed conformation as for the unbound receptor conformation. In addition, the set of amide hydrogens on the amino acids which make up the solvent accessible portion of the receptor structure may not be the same for different perturbed conformations that are induced in the receptor by different ligands (e.g., different drug candidates). Certain amide hydrogens capable of solvent interaction in the unbound receptor may not efficiently interact with the solvent in the receptor's perturbed conformation. Also, certain amide hydrogens capable of solvent interaction in one ligand-induced perturbed conformation may not efficiently interact with the solvent in a different perturbed conformation induced by a different ligand. Amide hydrogens that have changed the degree of hydrogen bonding in the unbound receptor as compared to the ligand bound receptor will afford perturbations in exchange rates.

V. Definition of Conformational Perturbation of a Receptor

A. Determination of Changes in Hydrogen Exchange Profiles of a Receptor vs. Receptor Complexes

The definition of a conformational perturbation induced in a receptor by binding interaction with a ligand comprises determination of a difference between the conformation of the receptor and the conformation induced in the receptor by the binding interaction with the ligand to form a complex. This determination may be accomplished according to the invention by analysis of the change in hydrogen exchange profile that occurs when the receptor binds to a ligand such as a selected ligand or a drug candidate. Preferably, the percent of hydrogen-exchanged for isotopic hydrogen is determined for each peptide amide hydrogen in the receptor and in the receptor complex. Optionally, the percent of hydrogen exchanged for isotopic hydrogen may be determined for each peptide fragment obtained by fragmentation of the isotopically-exchanged receptor and complex. Preferably, according to the invention, the difference in the percent of hydrogen exchanged for isotopic hydrogen is calculated between each peptide amide or peptide fragment in the receptor, and the corresponding peptide amide or peptide fragment in the complex (i.e., the receptor bound either to the selected ligand or to a drug candidate). Data showing the difference in hydrogen exchange profile between the receptor complex and the unbound receptor may, for example, comprise a tabulation of calculated differences in the percentage of isotopic hydrogen exchange for each peptide amide or each peptide fragment.

In some instances, a lower percent of hydrogen is shown to be exchanged in a particular peptide amide or peptide fragment in the complex than in the unbound receptor. In such an instance, the peptide amide or peptide fragment is thereby shown to be more protected (i.e., less solvent accessible) or the amide hydrogens are involved in a greater number of hydrogen bonds or stronger hydrogen bonds, in the complex than in the unbound receptor. In other instances, a higher percent of hydrogen is shown to be exchanged in a particular peptide amide or peptide fragment in the complex than in the unbound receptor. In the latter instance, the peptide amide or peptide fragment is shown to be less protected (i.e., more solvent accessible) in the complex than in the unbound receptor.

VI. Comparison of Receptor Conformational Perturbations.

Comparison of different receptor conformational perturbations to determine the similarity between them may be performed by cluster analysis.

A dataset suitable for use in cluster analysis may comprise tabulation of hydrogen exchange data, as generated in the practice of the present invention. One example of such a tabulated dataset is Table 2 in Example 1 below. Each row in Table 2 represents a different peptide fragment. Each column in Table 2 represents the PPARγ receptor bound to a different drug candidate (C1-C18). Each data point represents the perturbation of the peptide averaged across all H/D exchange time points. In Table 2, each column represents a hydrogen exchange profile, as described herein. Alternatively the data may comprise data from individual time points and the exchange profile at different time points could be compared.

Clustering of the columns of a dataset, like that of Table 2, serves to group similar receptor/ligand complexes. Alternately, clustering of the rows of a dataset, like that of Table 2, serves to group peptides with similar perturbation patterns. Such clustering of different peptides may demonstrate linked conformational changes in the structure of the receptor.

One computer program that may be employed to cluster data in the practice of the invention is CLUSTER 3.0. See, M. J. L. de Hoon, et al., Open Source Clustering Software, Bioinformatics, 2003, the entire disclosure of which is incorporated herein by reference. Input to CLUSTER 3.0 is a dataset as described above and exemplified by the data of Table 2. Output from CLUSTER 3.0 comprises simple text files that describe the inputted dataset and information including a measure of the distance between individual data items (rows or columns and thus peptides or receptor/ligand complexes).

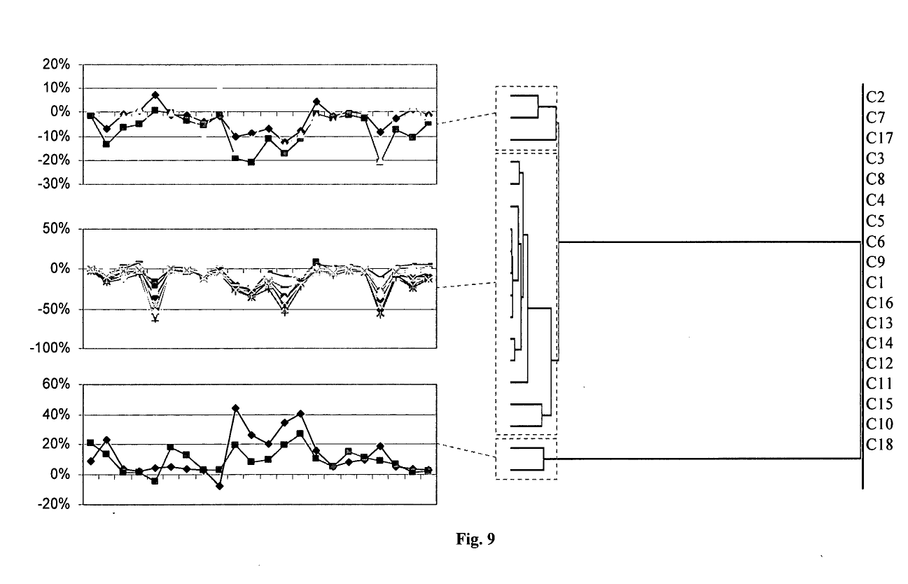

Another computer program which may be employed in the analysis of hydrogen exchange data, in the practice of this invention, is JAVA TREEVIEW. See http://jtreeview.sourceforge.net/. JAVA TREEVIEW may be employed to read and display the output from CLUSTER 3.0 in the form of a dendrogram (i.e., a binary tree wherein the leaves represent individual data items). For the present invention, each leaf in the dendrogram represents a hydrogen exchange profile for a receptor or receptor/ligand complex. The branch lengths represent the degree of similarity between different data. The shorter the branch length connecting two data in the dendrogram, the more similar are those data. An example of representation of perturbation data as a dendrogram is in FIG. 9, which shows the hierarchical grouping of H/D-Ex profiles for drug candidates C1-C18.

The practice of the invention is illustrated by the following non-limiting examples.

### EXAMPLES

### Example 1

### H/D-Ex Profiles of PPARγ LBD with and without Ligands

A. Preparation of Samples of PPARγ LBD.

PPARγ LBD protein was prepared as a stock solution in a buffer, as follows.

PPARγ LBD (33 kDa, 266 residues, of which sequence 28 to 293 corresponds to amino acid sequence 240-505 based on the amino acid numbering of full length PPARγ) was prepared in a concentration of 15 mg/mL (450 μM) in a buffer containing 20 mM Tris, 100 mM NaCl, 100 mM EDTA, and 1 mM BME at pH=8.0.

The PPARγ LBD protein stock solution was dissolved in a buffer (20 mM Tris, 100 mM NaCl, 2 mM EDTA, and 5 mM DTT at pH=8.0) to obtain a PPARγ LBD concentration of 10 μM. Two samples of diluted PPARγLBD solution (98 μL of the 10 μM solution) were prepared. To one 98 μL sample of PPARγ LBD was added 2 mL of dimethylsulfoxide (DMSO), and to the other 98 μL sample of PPARγ LBD was added 2 μL of DMSO containing 10 μM of the ligand (either compound C1, C2, C3, C4, C5, C6, C7, C8, C9, C10, C11, C12, C13, C14, C15, C16, C17, or C18) to form a PPARγ LBD-ligand solution. The concentration of the components in the samples was: 10 μM of the PPARγ LBD, 2% DMSO and (for samples containing a ligand) 200 μM of the ligand.

B. Deuterium On-Exchange of PPAR LBD Proteins

Deuterium on-exchange was initiated by mixing 4 μL of the PPARγLBD or PPARγ LBD-ligand solution with 16 μL of D₂O buffer (20 mM Tris, 100 mM NaCl, pH 8.0) to form a deuterium exchange solution. In the deuterium exchange solution, the PPARγ LBD concentration was 2 μM, the ligand concentration was 40 μM, the DMSO concentration was 0.4%, and the D₂O concentration was 80%. Each deuterium exchange reaction was quenched with 30 μl of an aqueous solution containing 2M urea and 1M tris(2-carboxyethyl) phosphine (TCEP) following a selected on-exchange time interval (30, 100, 300, 1000, 3000 and 10,000 seconds).

C. Fragmentation of the Isotopic Hydrogen-Exchanged PPARγ LBD

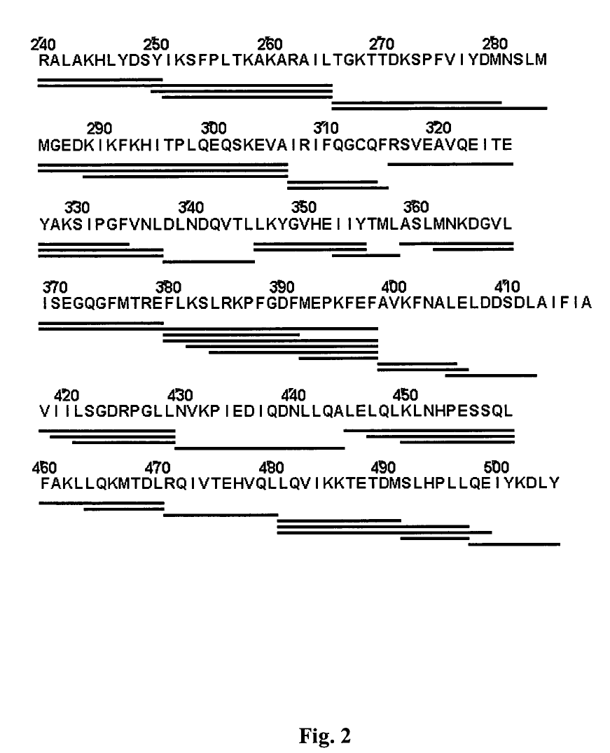

The fragmentation and separation conditions for PPARγ LBD (liganded and unliganded) are as follows. PPARγ LBD was exposed to immobilized pepsin at 0° C. and at a pH of about 2.3. The receptor was in contact with pepsin for a time interval of 2 minutes. The resulting peptide mixture is trapped and separated using reverse-phase HPLC. The separated peptides are eluted directly into an electrospray mass spectrometer. The peptides resulting from the fragmentation of PPARγ LBD represented 261 of the 266 total amino acid residues comprising the PPARγ LBD and covering ˜98% of the protein amino acid sequence (See, FIG. 2).

D. H/D-Ex Profiles of PPARγ LBD without Ligands.

Deuteration build-up was monitored at five on-exchange time points; 30, 100, 300, 1,000, and 3,000 seconds. The PPARγ LBD peptide fragments that were monitored for deuterium buildup are listed in Table 1. The data in Table 1 correlate the hydrogen exchange profiles of FIGS. 3a-3w through FIGS. 8a-8w with the sequence of each of the 22 peptide fragments observed in the experiment. The charge state is listed for the ion corresponding to each peptide fragment, which ion is monitored by mass spectrometry. The mass spectrometry data is recorded as a mass-to-charge ratio. Two sequence number ranges are listed for each peptide fragment. The “raw sequence” numbers correspond to the numbering of the amino acid residues in PPARγ LBD. The “adjusted sequence” number range corresponds to the numbering of the amino acid residues in full length PPARγ.

Twenty-two peptide fragments were found to be useful for following on-exchange characteristics. The twenty-two peptide fragments represented 261 of the 266 total amino acid residues (˜98%) comprising the PPARγ LBD. The deuterium build-up curves for these twenty-two peptide fragments are displayed in FIGS. 3a-3w, which depicts data for PPARγ LBD without bound ligand with the symbol (-♦-).

TABLE 1

| Fragment | Raw | Adjusted | Charge |
|---|---|---|---|
| # | sequence | sequence | state |
| 1 | 28-38 | 240-250 | 2 |
| 2 | 38-53 | 250-265 | 2 |
| 3 | 54-68 | 266-284 | 2 |
| 4 | 73-94 | 285-306 | 2 |
| 5 | 95-103 | 307-315 | 1 |
| 6 | 115-125 | 327-337 | 1 |
| 7 | 126-133 | 338-345 | 1 |
| 8 | 134-143 | 346-355 | 1 |
| 9 | 141-146 | 353-358 | 1 |
| 10 | 147-156 | 359-368 | 1 |
| 11 | 157-167 | 369-379 | 1 |
| 12 | 168-179 | 380-391 | 2 |
| 13 | 180-186 | 392-398 | 1 |
| 14 | 187-193 | 399-405 | 1 |
| 15 | 193-200 | 405-412 | 1 |
| 16 | 207-217 | 419-429 | 1 |
| 17 | 233-247 | 445-459 | 2 |
| 18 | 248-258 | 460-470 | 1 |
| 19 | 259-268 | 471-480 | 1 |
| 20 | 269-279 | 481-491 | 1 |
| 21 | 280-285 | 492-497 | 1 |
| 22 | 286-293 | 498-505 | 1 |

E. H/D-Ex Profiles of PPARγ LBD Bound to Drug Candidates C1 to C18.

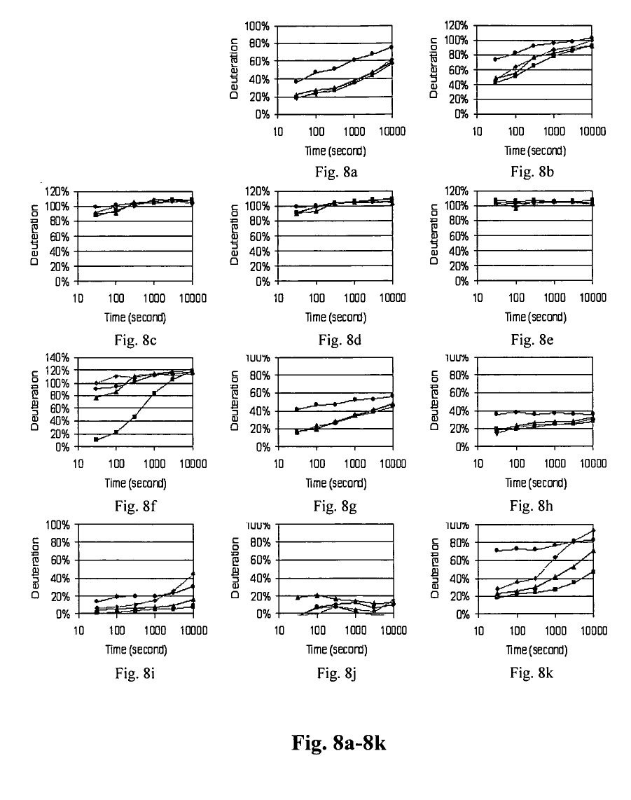

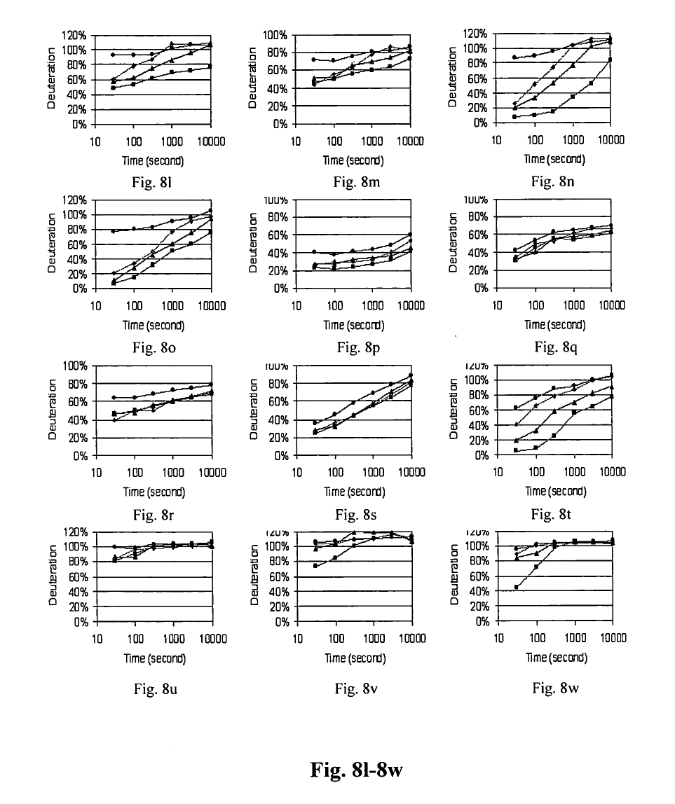

H/D-Ex profiles of PPARγ LBD were measured in the presence of drug candidates under the same conditions employed for the unliganded PPARγ LBD protein. The same peptides previously described in Table 1 were monitored for exchange behavior in the presence of each of the eighteen ligands C1 to C18. The deuterium build-up for ligand-bound PPARγ LBD protein was compared to that of the unliganded PPARγ LBD protein. H/D exchange data for PPARγLBD upon binding of each of drug candidates C1-C18 is displayed in S. 3a-3w through FIGS. 8a-8w.

H/D-Ex data for PPARγ LBD upon binding of drug candidates C1, C2 and C3 is displayed in FIGS. 3a-3w.

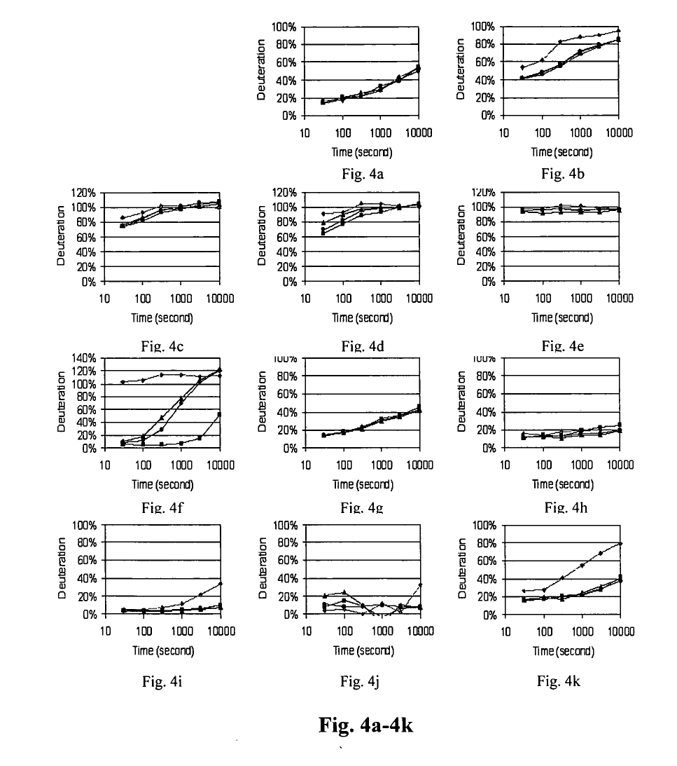

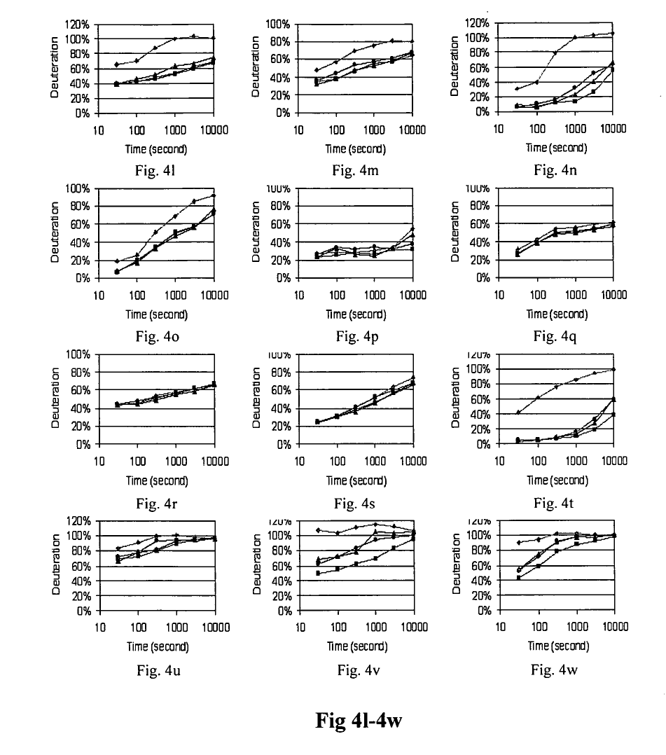

H/D-Ex data for PPARγ LBD upon binding of drug candidates C4, C5 and C6 is displayed in FIGS. 4a-4w.

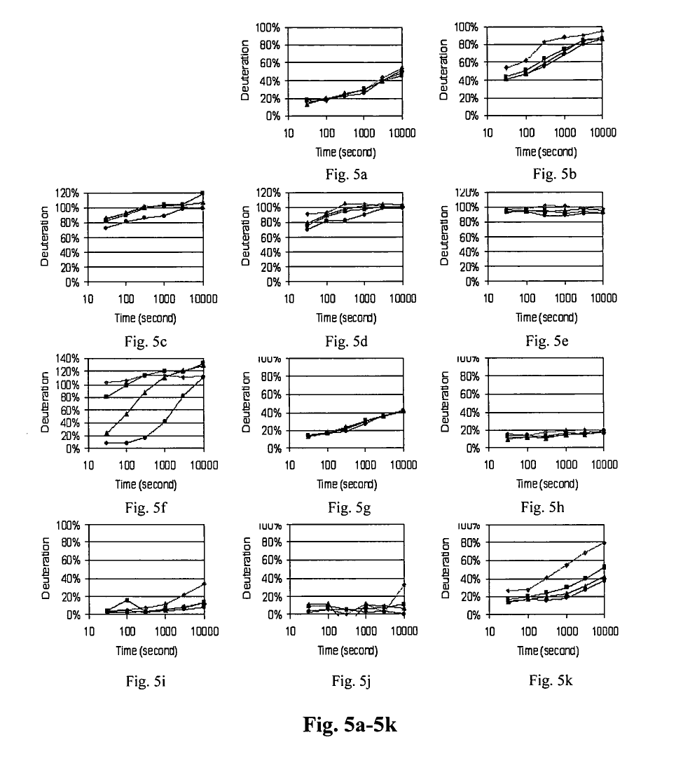

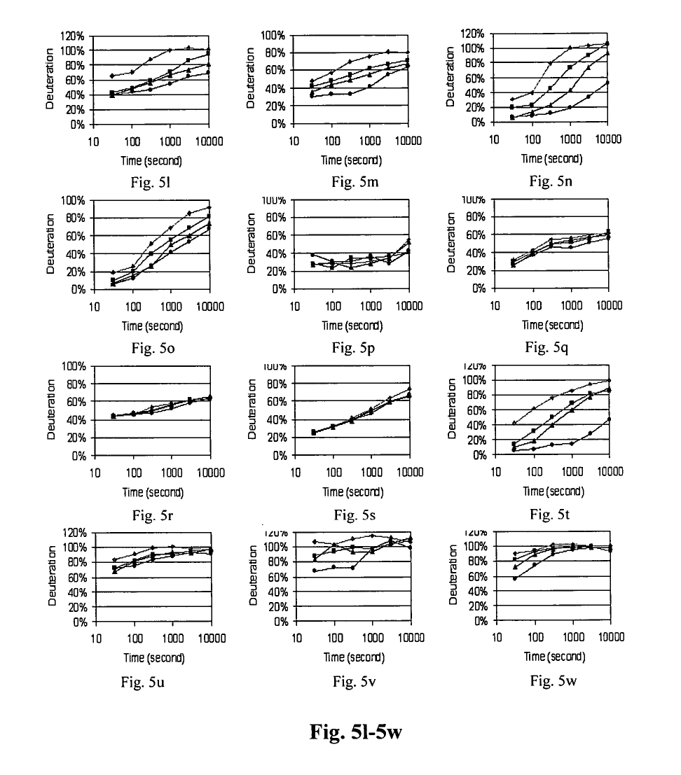

H/D-Ex data for PPARγ LBD upon binding of drug candidates C7, C8 and C9 is displayed in FIGS. 5a-5w.

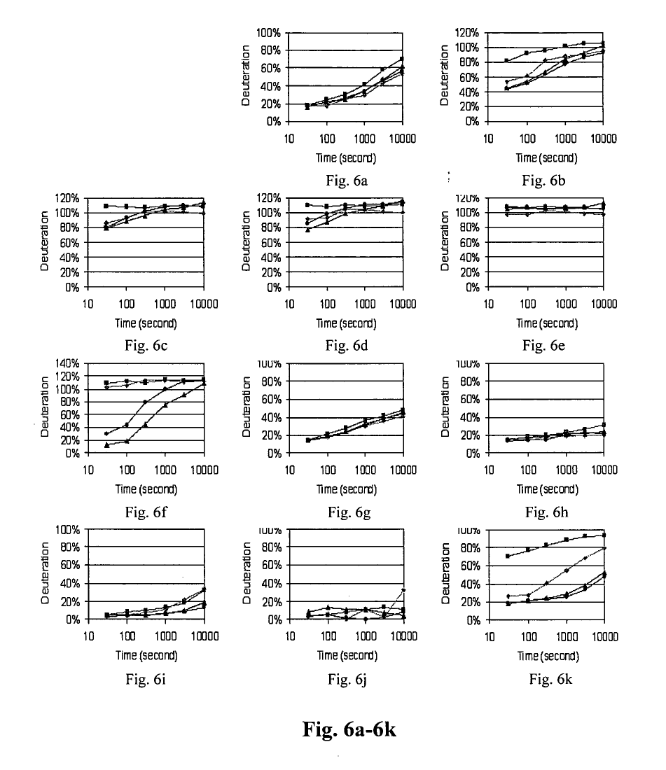

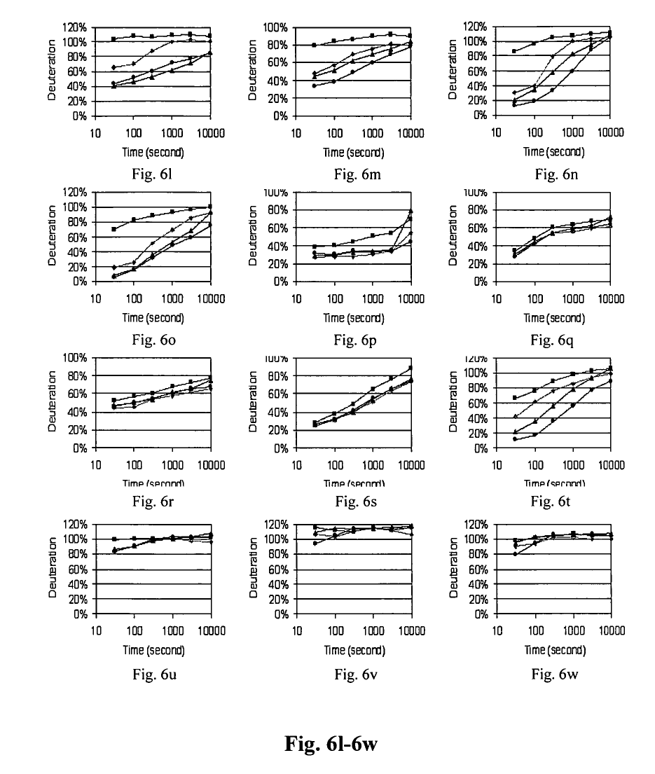

H/D-Ex data for PPARγ LBD upon binding of drug candidates C10, C11 and C12 is displayed in FIGS. 6a-6w.

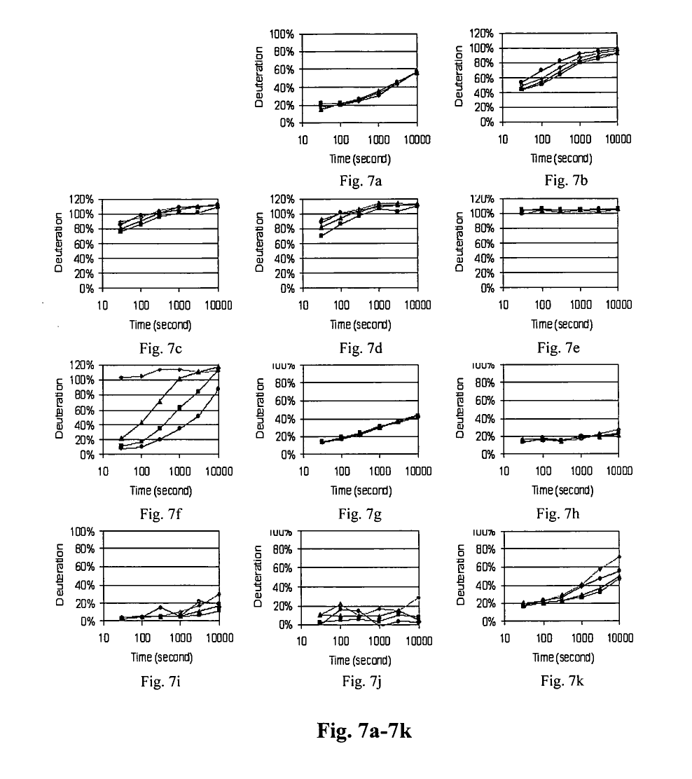

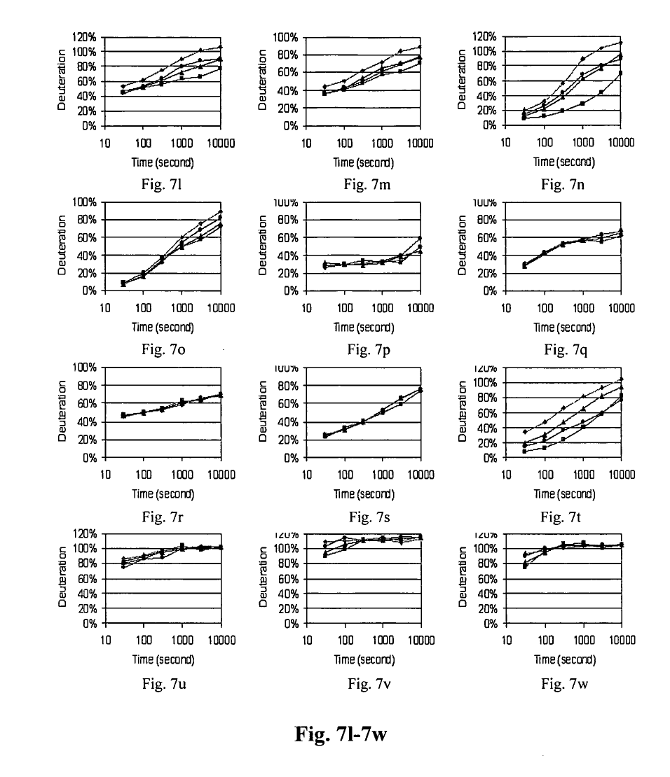

H/D-Ex data for PPARγ LBD upon binding of drug candidates C13, C14 and C15 is displayed in FIGS. 7a-7w.

H/D-Ex data for PPARγ LBD upon binding of drug candidates C16, C17 and C15 is displayed in FIGS. 8a-8w.

F. Conformational Perturbation PPARγ LBD Induced by Binding to Ligands

Conformational perturbation of PPARγ LBD was revealed by analyzing the difference in the H/D-Ex profile of PPARγ LBD bound to a ligand and unliganded PPARγ LBD. The resulting perturbation data for each of the ligands are tabulated in Table 2. The data columns in Table 2 represent the 18 drug candidates tested. The data rows represent the 22 peptide fragments monitored for changes in the H/D-Ex profile.

TABLE 2

| Fragment # | C1 | C2 | C3 | C4 | C5 | C6 | C7 | C8 | C9 |
|---|---|---|---|---|---|---|---|---|---|
| 1 | −1% | −1% | 0% | −1% | 0% | −2% | −2% | −1% | −2% |
| 2 | −14% | −7% | −12% | −17% | −16% | −15% | −14% | −15% | −17% |
| 3 | −5% | −1% | −3% | −11% | −4% | −8% | −6% | −3% | −12% |
| 4 | 0% | 1% | −2% | −3% | −5% | −2% | −5% | −4% | −7% |
| 5 | −35% | 7% | −16% | −94% | −46% | −52% | 1% | −22% | −65% |
| 6 | −1% | −1% | 0% | 1% | −1% | 0% | 0% | −1% | −1% |
| 7 | −1% | −1% | −1% | 0% | −4% | −3% | −3% | −4% | −2% |
| 8 | −8% | −4% | −8% | −8% | −9% | −8% | −5% | −8% | −9% |
| 9 | −6% | −2% | −8% | 0% | 1% | −3% | −1% | −3% | −6% |
| 10 | −21% | −10% | −21% | −25% | −25% | −26% | −19% | −24% | −28% |
| 11 | −27% | −9% | −24% | −36% | −31% | −35% | −21% | −27% | −35% |
| 12 | −14% | −7% | −15% | −19% | −19% | −15% | −11% | −16% | −26% |
| 13 | −38% | −13% | −39% | −56% | −50% | −47% | −17% | −34% | −54% |
| 14 | −17% | −8% | −14% | −17% | −17% | −17% | −11% | −18% | −22% |
| 15 | −3% | 5% | 9% | −6% | −2% | −1% | −1% | −1% | 1% |
| 16 | −5% | −2% | −3% | −4% | −5% | −5% | −3% | −3% | −7% |
| 17 | −1% | 0% | 0% | 0% | −2% | 0% | −1% | 0% | −3% |
| 18 | −2% | −1% | −1% | −2% | −4% | −4% | −3% | −3% | −3% |
| 19 | −38% | −8% | −37% | −62% | −56% | −55% | −21% | −27% | −57% |
| 20 | −8% | −2% | −8% | −11% | −10% | −7% | −7% | −8% | −11% |
| 21 | −9% | 1% | −21% | −40% | −20% | −24% | −10% | −11% | −23% |
| 22 | −10% | −1% | −11% | −22% | −12% | −13% | −5% | −6% | −13% |
| Fragment # | C10 | C11 | C12 | C13 | C14 | C15 | C16 | C17 | C18 |
| 1 | 9% | 3% | 2% | 6% | 1% | 1% | 1% | 1% | 21% |
| 2 | 23% | −5% | −9% | −6% | −4% | 6% | −9% | −4% | 13% |
| 3 | 3% | 0% | 5% | −11% | −4% | −2% | −2% | −2% | 1% |
| 4 | 2% | 9% | 8% | 0% | 0% | −1% | 0% | 1% | 1% |
| 5 | 4% | −51% | −30% | −54% | −30% | −72% | −43% | −6% | −5% |
| 6 | 5% | 2% | 1% | 1% | 1% | 0% | 0% | 0% | 18% |
| 7 | 3% | 2% | 1% | −1% | −1% | −1% | −1% | 2% | 13% |
| 8 | 3% | −5% | −7% | −6% | −4% | 0% | −12% | −10% | 3% |
| 9 | −8% | 0% | −6% | −11% | −7% | −11% | −4% | 11% | 3% |
| 10 | 44% | −19% | −21% | −13% | −11% | −5% | −26% | −16% | 19% |
| 11 | 26% | −28% | −23% | −22% | −15% | −11% | −26% | −11% | 8% |
| 12 | 20% | −4% | −13% | −15% | −9% | −11% | −15% | −2% | 10% |
| 13 | 34% | −10% | −23% | −38% | −17% | −15% | −42% | −14% | 19% |
| 14 | 40% | −11% | −17% | −7% | −8% | −5% | −19% | −9% | 27% |
| 15 | 15% | 7% | 1% | 0% | −1% | 2% | −4% | −2% | 10% |
| 16 | 5% | 3% | 1% | −3% | −2% | 0% | −5% | −4% | 5% |
| 17 | 8% | 4% | 3% | 1% | 1% | 0% | −1% | 2% | 15% |
| 18 | 9% | 2% | 1% | −2% | 0% | 0% | −3% | 1% | 11% |
| 19 | 18% | −11% | −28% | −33% | −15% | −28% | −45% | −20% | 8% |
| 20 | 5% | 3% | 2% | −2% | −2% | −4% | −4% | 1% | 6% |
| 21 | 4% | 6% | 1% | −3% | −2% | 2% | −12% | 2% | 1% |
| 22 | 2% | 6% | 2% | −3% | −2% | 0% | −14% | −2% | 2% |

Table 2 shows the change in percent isotopic hydrogen exchanged into PPARγ LBD bound to drug candidates C1 to C18 as compared to unliganded PPARγ LBD. The difference in the percent isotopic hydrogen exchanged is shown for each of twenty-two peptide fragments generated by enzymatic fragmentation of unliganded PPARγ LBD and of PPARγ LBD bound to drug candidate C1 to C18 (as described in Example 1 section C). The definition of the sequence designation for the twenty-two peptides is described in Example 1 section D and Table 1.

The H/D-Ex profiles for unliganded PPARγ LBD and of PPARγ LBD bound to drug candidates C1 to C18 were clustered by drug candidate. The results of the clustering are shown in FIG. 9.

The clustering results depicted in FIG. 9 were generated by the use of JAVA TREEVIEW. At a selected branch length, the dendrogram in FIG. 9 is dissected into three separate groups of H/D-Ex profiles. The H/D-Ex profiles in each of those three groups are plotted onto line charts where the Y-axis depicts percentage deuteration and the X-axis depicts each of the 18 drug candidates C1-C18 in sequential order. The H/D-Ex profiles within each group are more similar to each other than to the H/D-Ex profiles in any other group.

For the clustering results depicted in FIG. 9 the clustering mechanism in CLUSTER 3.0 was set as “centroid linkage.” Use of the “centroid linkage” setting in the clustering shown in FIG. 9 makes the clustering process robust against the undue influence of outlying perturbation values. Also for the clustering results depicted in FIG. 9 the distance function in CLUSTER 3.0 was set to “uncentered correlation.” The use of the “uncentered correlation” setting serves to take into account the magnitude of the difference between H/D-Ex profiles. In comparison a standard Pearson correlation would assign a perfect similarity even if the two H/D-Ex profiles were offset from one another.

The H/D-Ex profiles for PPARγ LBD bound to drug candidates C1 to C18 were divided into groups such that the H/D-Ex profiles within each group had an uncentered correlation value of 0.79 or greater. The profiles within each group were charted separately.

The above clustering provides the prediction that the activity of drug candidate C1 is similar to that of drug candidate C18 (a known receptor ligand) and quite distinct from all of the other drug candidates tested. Drug candidates C2 and C7 are similar in activity to drug candidate C17 (a known receptor ligand). All of the other drug candidates including C16 (a known receptor ligand) are distinct from the above two groups of drug candidates.

The present invention may be embodied in other specific forms without departing from the spirit or essential attributes thereof and, accordingly, reference should be made to the appended claims, rather than to the foregoing specification, as indication of the scope of the invention.

What is claimed is:

1. A method of screening a drug candidate for a selected pharmacological activity, said method comprising:
(a) selecting a receptor that demonstrates a perturbation of conformation when bound to a selected ligand, wherein said selected ligand is identified with the selected pharmacological activity;
(b) generating a hydrogen exchange profile of the receptor;
(c) generating a hydrogen exchange profile of a first receptor complex comprising the receptor bound to said selected ligand;
(d) defining a first perturbation of the receptor conformation, which perturbation is induced by binding of the receptor to the selected ligand;
(e) generating a hydrogen exchange profile of a second receptor complex comprising the receptor bound to said drug candidate;
(f) defining a second perturbation of the receptor conformation which perturbation is induced by binding of the receptor to the drug candidate; and
(g) comparing the first perturbation to the second perturbation, the similarity between the two perturbations of the receptor conformation being predictive of the drug candidate having the selected pharmacological activity.

2. The method according to claim 1 wherein the drug candidate screened in the screening method is selected by computer-assisted modeling of the selected receptor.

3. The method according to claim 1 wherein said computer-assisted modeling comprises:
(a) modeling a binding interaction of at least one compound with the receptor to identify at least one potential receptor ligand; and
(b) selecting at least one potential receptor ligand as a drug candidate.

4. The method according to claim 1 wherein said computer-assisted modeling comprises:
(a) predicting at least one hydrogen exchange profile of the selected receptor bound to at least one potential drug candidate by modeling probable conformational states of the receptor bound to the at least one potential drug candidate;
(b) defining at least one conformational perturbation of the receptor predicted to be induced by binding of the receptor to the at least one potential drug candidate; and
(c) selecting a drug candidate wherein the predicted conformational perturbation is similar to a conformational perturbation of the receptor induced by binding of the receptor to a selected ligand, which selected ligand is identified with a selected pharmacological activity.

5. The method according to claim 1 wherein defining the first perturbation comprises calculating the difference between the hydrogen exchange profile of the receptor and the hydrogen exchange profile of the receptor bound to the selected ligand.

6. The method according to claim 1 wherein defining the second perturbation comprises calculating the difference between the hydrogen exchange profile of the receptor and the hydrogen exchange profile of the receptor bound to the drug candidate.

7. The method according to claim 2 wherein the selected receptor is a nuclear receptor.

8. The method according to claim 7, wherein the nuclear receptor is selected from the group consisting of glucocorticoid receptor, estrogen receptor, peroxisome proliferator-activated receptor, vitamin D receptor, liver X receptor and retinoic X receptor.

9. The method according to claim 2 wherein the selected receptor is a kinase.

10. The method according to claim 9 wherein the kinase is selected from the group consisting of c-JUN N-terminal kinase, glucokinase and protein tyrosine phosphatase 1b.

11. The method according to claim 2 wherein the selected receptor is a G-protein coupled receptor.

12. The method according to claim 11 wherein the G-protein coupled receptor is an AMPA receptor,

13. The method according to claim 2 wherein the selected receptor is a transcription factor other than a nuclear receptor.

14. The method according to claim 13 wherein the transcription factor is selected from the group consisting of TFIIA, TFIIB, TFIIC, TFIID, TFIIE, TFIIF, TFIIH, TFIIK (CTD kinase), TATA binding protein, RelA, RelB, p50/p105, p52/p100, X-Rel2, and NF-kB.

15. The method according to claim 2, wherein the step of generating a hydrogen exchange profile comprises determining the quantity of isotopic hydrogen or the rate of hydrogen exchange, or both the quantity of isotopic hydrogen and the rate of hydrogen exchange, of a plurality of peptide amide hydrogens exchanged for said isotopic hydrogen in a receptor or receptor complex that is hydrogen-exchanged with a hydrogen isotope other than ¹H.

16. The method according to claim 15, wherein the step of determining the quantity of isotopic hydrogen or the rate of hydrogen exchange, or both the quantity of isotopic hydrogen and the rate of hydrogen exchange, comprises the steps of:
(a) contacting the selected receptor or receptor complex with an isotopic hydrogen exchange reagent for a selected time interval to form a isotopic hydrogen-exchanged receptor or receptor complex;
(b) under slow hydrogen exchange conditions, progressively degrading the isotopic hydrogen-exchanged receptor or receptor complex to obtain a series of sequence-overlapping peptide fragments;
(c) measuring the amount of isotopic hydrogen contained in each peptide fragment; and
(d) correlating the amount of isotopic hydrogen contained in each peptide fragment with an amino acid sequence of the receptor or receptor complex from which the peptide fragment was generated, thereby determining the quantity of isotopic hydrogen or the rate of hydrogen exchange, or both the quantity of isotopic hydrogen and the rate of hydrogen exchange, of a plurality of peptide amide hydrogens exchanged for isotopic hydrogen in the receptor or receptor complex.

17. The method according to claim 16 in which said progressively degrading comprises contacting the isotopic hydrogen-exchanged receptor with an acid-stable endopeptidase under slow hydrogen exchange conditions.

18. The method according to claim 17 wherein the acid-stable endopeptidase is immobilized on a solid-phase support.

19. The method according to claim 18 wherein the acid-stable endopeptidase is selected from the group consisting of pepsin, Newlase, Aspergillus proteases, protease type XIII, and combinations thereof.

20. The method according to claim 16 in which said progressively degrading comprises:
(a) fragmenting the isotopic hydrogen-exchanged receptor into a plurality of peptide fragments under slow hydrogen exchange conditions;
(b) identifying which peptide fragments of said plurality of peptide fragments are isotopic hydrogen-exchanged; and
(c) sequentially terminally degrading the isotopic hydrogen-exchanged peptide fragments under slow hydrogen exchange conditions, to obtain a series of subfragments, wherein each subfragment of the series is composed of from about one to about five fewer amino acid residues than the preceding subfragment in the series.

21. The method according to claim 20 wherein sequentially terminally degrading comprises reaction of the isotopic hydrogen-exchanged peptide fragments with an acid-resistant carboxypeptidase under slow hydrogen exchange conditions.

22. The method according to claim 21 in which said acid-resistant carboxypeptidase is selected from the group consisting of carboxypeptidase P, carboxypeptidase Y, carboxypeptidase W, carboxypeptidase C and combinations thereof.

23. A method according to claim 15 wherein said isotopic hydrogen is deuterium.

24. A method according to claim 23, wherein the presence and quantity of deuterium on said subfragments of the isotopic hydrogen-exchanged receptor is determined by measuring the mass of said subfragments.

25. A method according to claim 24, wherein said measuring is performed using mass spectrometry.

26. A method according to claim 15 further comprising the use of conditions that effect protein denaturation under slow hydrogen exchange conditions prior to generation of said fragments.

27. A method according to claim 15 further comprising disrupting disulfide bonds in the isotopic hydrogen-exchanged receptor prior to generating said fragments.

28. A method according to claim 27, wherein said disrupting comprises contacting the isotopic hydrogen-exchanged receptor with a water-soluble phosphine.


SEQUENCE LISTING (2 sequences)

SEQ ID NO: 1 - protein, 266 aa, Artificial Sequence
  Homo sapiens PPAR gamma ligand binding domain
RALAKHLYDSYIKSFPLTKAKARAILTGKTTDKSPFVIYDMNSLMMGEDKIKFKHITPLQEQSKEVAIRIFQGCQFRSVEAVQEITEYAKSIPGFVNLDLNDQVTLLKYGVHEIIYTMLASLMNKDGVLISEGQGFMTREFLKSLRKPFGDFMEPKFEFAVKFNALELDDSDLAIFIAVIILSGDRPGLLNVKPIEDIQDNLLQALELQLKLNHPESSQLFAKLLQKMTDLRQIVTEHVQLLQVIKKTETDMSLHPLLQEIYKDLY

SEQ ID NO: 2 - protein, 505 aa, Homo sapiens
MGETLGDSPIDPESDSFTDTLSANISQEMTMVDTEMPFWPTNFGISSVDLSVMEDHSHSFDIKPFTTVDFSSISTPHYEDIPFTRTDPVVADYKYDLKLQEYQSAIKVEPASPPYYSEKTQLYNKPHEEPSNSLMAIECRVCGDKASGFHYGVHACEGCKGFFRRTIRLKLIYDRCDLNCRIHKKSRNKCQYCRFQKCLAVGMSHNAIRFGRMPQAEKEKLLAEISSDIDQLNPESADLRALAKHLYDSYIKSFPLTKAKARAILTGKTTDKSPFVIYDMNSLMMGEDKIKFKHITPLQEQSKEVAIRIFQGCQFRSVEAVQEITEYAKSIPGFVNLDLNDQVTLLKYGVHEIIYTMLASLMNKDGVLISEGQGFMTREFLKSLRKPFGDFMEPKFEFAVKFNALELDDSDLAIFIAVIILSGDRPGLLNVKPIEDIQDNLLQALELQLKLNHPESSQLFAKLLQKMTDLRQIVTEHVQLLQVIKKTETDMSLHPLLQEIYKDLY